(19) United States
(12) Patent Application Publication
(10) Pub. No.: US 2015/0363843 A1
(43) Pub. Date: Dec. 17, 2015

(54) DYNAMIC PROVISIONING OF PICK-UP, DELIVERY, TRANSPORTATION, AND/OR SORTATION OPTIONS

(71) Applicant: UNITED PARCEL SERVICE OF AMERICA, INC., Atlanta, GA (US)

(72) Inventors: GREG LOPPATTO, ATLANTA, GA (US); CHARLENE THOMAS, ATLANTA, GA (US); CHRIS GRUBB, ATLANTA, GA (US)

(21) Appl. No.: 14/694,313

(22) Filed: Apr. 23, 2015

Related U.S. Application Data
(60) Provisional application No. 61/983,304, filed on Apr. 23, 2014.

(51) Int. Cl. G06Q 30/02; G06Q 10/08

(52) U.S. Cl. CPC G06Q 30/0283; G06Q 10/083

(57) ABSTRACT

Systems, methods, apparatus, and computer program products are provided for programmatically determining/identifying for determining a delivery time and/or cost for an item to be delivered and allowing customer selection of one of the delivery windows. One example embodiment may include a method comprising receiving customer location information/data indicative of a customer location, querying at least one of (a) a historical database, (b) a dynamic database, (c) predictive database, or (d) a combined database to determine a cost associated with each of the one or more time frames/periods and whether any pick-up, transportation, sortation, and/or delivery criteria associated with the cost, and providing the one or more time frames/periods and the cost associated with each of the one or more time frames.

### CROSS-REFERENCE TO RELATED APPLICATIONS

This application claims priority to U.S. Provisional Application No. 61/983,304 filed Apr. 23, 2014, which is hereby incorporated herein in its entirety by reference.

### BACKGROUND

Shipping customers are increasing their expectations regarding various delivery services. Thus, new concepts are needed to enhance customer experiences and loyalty by improving the delivery experience. For example, whereas other systems are configured such that pick-ups/deliveries are often scheduled without regard for other pick-ups or deliveries, Applicant (carrier) has identified a need for synchronized delivery with anticipated and/or forecasted deliveries to the same or nearby addresses, on the same dates, and/or at the same times to increase and/or decrease density (e.g. reduce shipments on a delivery vehicle showing a possible over capacity situation), which would allow for more efficient delivery of items by, for instance, resulting in a reduction in emissions and fuel consumption, creating an improved customer experience (e.g., customer-selectable delivery windows each provided with associated costs, multiple deliveries at the same time versus separate deliveries, and/or the like).

### BRIEF SUMMARY

In general, embodiments of the present invention provide systems, methods, apparatus, and computer program products for encouraging customers of online retailers and/or online retailers to tender items according to specified criteria such that deliveries can be synchronized with anticipated and/or forecasted deliveries to the same or nearby addresses, on the same dates, and/or at the same times to increase or decrease density.

In some embodiments, a method for determining a delivery cost for an item to be delivered may be provided, the method comprising receiving customer location information/data indicative of a customer location, the customer location information/data selected from the group consisting of entered information/data, customer profile information/data, or address information/data associated with a customer computing entity, and determining one or more time frames/periods from a plurality of carrier time frames/periods in which delivery of the item is available based on the customer location and a cost associated with each of the one or more time frames.

In some embodiments, the method may further comprise receiving a promised delivery date, wherein the determining of the one or more times frames/periods is dependent on the promised delivery date. In some embodiments, the method may further comprise determining, based on the customer location information/data, whether synchronized delivery with a stop creator ship is possible to increase delivery density or influence delivery parameter selections. In some embodiments, the method may further comprise normalizing the customer location information/data to determine a particular address. In some embodiments, the method may further comprise querying at least one of (a) a historical database, (b) a dynamic database (real time), or (c) a predicted database, or (d) a combination of databases/data to determine if cost and/or logistics capability information is available.

In some embodiments, the method may further comprise, in the event that only the historical database is queried, determining if costs and/or logistics capability are available for the particular address or surrounding address, the query result indicating one or more of (a) whether costs are available, (b) the type of costs including address match or nearby address match with an anticipated stop creator shipment, (c) actual costs, and (d) corresponding dates or times.

In some embodiments, the method may further comprise, in the event only the dynamic database (real time) is queried, determining if synchronized delivery with one or more stop creator items is possible and if costs and/or logistics capability are available for the particular address or the surrounding address, determining delivery criteria to be met to achieve synchronized delivery with the one or more stop creator items and to receive the costs and corresponding dates or times, the delivery criteria based on an ability to synchronize the delivery with forecasted deliveries to the particular address or the surrounding address and includes specific delivery dates or ranges of dates.

In some embodiments, the method may further comprise, in the event only the predicted database (e.g. big data, learning systems) is queried, determining if synchronized delivery with one or more stop creator items is possible and if costs and/or logistics capability are available for the particular address or the surrounding address, determining delivery criteria to be met to achieve synchronized delivery with the one or more stop creator items and to receive the costs and corresponding dates or times, the delivery criteria based on an ability to synchronize the delivery with forecasted deliveries to the particular address or the surrounding address and includes specific delivery dates or ranges of dates.

In some embodiments, the method may further comprise in the event a combined historical and dynamic database is queried, determining (a) if synchronized delivery with one or more stop creator items is possible and (b) if costs are available for the particular address or a surrounding address, determining delivery criteria to be met to achieve synchronized delivery and to receive the costs and corresponding dates or times, wherein if the costs are based on historical information/data, there are not be any separate delivery criteria necessary to receive the costs, and wherein if the costs are based on dynamic information/data, the delivery criteria based on the ability to synchronize the delivery with forecasted deliveries to the particular address or the surrounding addresses and includes specific delivery dates/times or ranges of dates/times.

In some embodiments, the method may further comprise considering information/data received from the customer, the information/data received from the customer comprising one or more of vacation schedules, alternate delivery locations, or requested delivery days of the week.

In some embodiments, the method may further comprise accessing raw information/data from at least one of customer profile data, historical address profile information/data or PLD data, and applying one or more business rules to determine one or more of (a) if synchronized delivery with one or more stop creator items are possible, (b) if costs are available, or (c) any criteria that must be met to receive the costs.

In some embodiments, the method may further comprise subsequent to the synchronization/density/cost analysis, comparing the pick-up, transportation, sortation, and/or delivery criteria (all of which may be referred to herein interchangeably and/or logistics capability against the promised delivery dates, times, or time windows determined by the carrier system, and using the information/data, filtering the cost results to meet the promised dates, times, and/or time windows

In some embodiments, the method may further comprise subsequent to the synchronization/density/cost analysis, communicating pick-up or delivery information/data to the one or more retailer systems for the particular address, the pick-up and/or delivery information/data communicated via an API, user interface, integrated software, pop-up windows or other communication protocol or path.

In some embodiments, the pick-up and/or delivery information/data being indicative of one or more of the costs, dates, times, or time windows, actual costs including discount amounts or discount percentages, or delivery criteria that must be met to receive the determined/identified cost.

In some embodiments, the pick-up and/or delivery information/data being indicative of a tendered date and one or more associated tender locations for the shipment to receive the cost, the tender locations being one or more fulfillment centers or drop-ship locations associated with the customer, retailer, carrier and/or third party the method further comprising determining which tender locations to offer based on one or more of (a) volume in delivery lanes associated with the different locations, (b) time-in-transit, (c) proximity to delivery address, and (d) cost associated with the pick-up, (e) security, (f) ability to authenticate consignee (g) hazardous material/special handling instructions, (h) volume/cube in delivery vehicles (referred to herein logistics capabilities), delivery densities, and/or the like.

In some embodiments, the method may further comprise providing the pick-up, transportation, sortation, and/or delivery information/data comprising at least time-in-transit information/data, the pick-up or delivery information/data configured for use in calculating a tender date for the shipment for selected fulfillment centers or drop-ship locations.

In some embodiments, the fulfillment center being selected based at least in part on the required delivery service level necessary to meet the delivery date and the availability of the purchased items at the fulfillment center. In some embodiments, the method may further comprise periodically analyzing the dynamic information/data to determine if new stop creator items are received, receiving a repeat cost query after the retailer system has received the order to verify the cost, and in the event one or more new stop creator items are received between the initial determination and the receipt of the order resulting in a possible synchronization, or in the event one or more new stop creator items are received between the initial determination and the determined tender date, re-calculating the cost.

In some embodiments, the method may further comprise providing a unique identifier with the cost for use in identifying the shipment, wherein when the shipment is tendered to the carrier, capturing the unique identifier, and verifying whether the shipment criteria has been met to receive the determined/identified cost.

In some embodiments, an apparatus for determining a delivery cost for an item to be delivered may be provided, the apparatus comprising at least one processor and at least one memory including program code, the at least one memory and the program code configured to, with the processor, cause the apparatus to at least receive customer location information/data indicative of a customer location, the customer location information/data selected from the group consisting of entered information/data, customer profile information/data, or address information/data associated with a customer computing entity, and determine one or more time frames/periods from a plurality of carrier time frames/periods in which delivery of the item is available based on the customer location and a cost associated with each of the one or more time frames.

In some embodiments, the memory stores computer-readable instructions that, when executed, cause the processor to receive a promised delivery date, wherein the determining of the one or more times frames/periods is dependent on the promised delivery date. In some embodiments, the memory stores computer-readable instructions that, when executed, cause the processor to determine, based on the customer location information/data, whether synchronized delivery with a stop creator ship is possible to increase delivery density or influence delivery parameter selections. In some embodiments, the memory stores computer-readable instructions that, when executed, cause the processor to normalize the customer location information/data to determine a particular address. In some embodiments, the memory stores computer-readable instructions that, when executed, cause the processor to query at least one of (a) a historical database, (b) a dynamic database, (c) a predictive database, (d) a combined database (referred to herein individually as noted or collectively as “database) to determine if a cost is available.

In some embodiments, the memory stores computer-readable instructions that, when executed, cause the processor to in the event that only the historical database is queried, determine if costs are available for the particular address or surrounding address, the query result indicating one or more of (a) whether costs are available, (b) the type of costs including address match or nearby address match with an anticipated stop creator shipment, (c) actual costs, and (d) corresponding dates or times.

In some embodiments, the memory stores computer-readable instructions that, when executed, cause the processor to in the event only the dynamic database is queried, determine if synchronized delivery with one or more stop creator items is possible and if costs are available for the particular address or the surrounding address, determine delivery criteria to be met to achieve synchronized delivery with the one or more stop creator items and to receive the costs and corresponding dates or times, the delivery criteria based on an ability to synchronize the delivery with forecasted deliveries to the particular address or the surrounding address and includes specific delivery dates or ranges of dates.

In some embodiments, the memory stores computer-readable instructions that, when executed, cause the processor to in the event a combined historical and dynamic database is queried, determine (a) if synchronized delivery with one or more stop creator items is possible and (b) if costs are available for the particular address or a surrounding address, determine delivery criteria to be met to achieve synchronized delivery and to receive the costs and corresponding dates or times, wherein if the costs are based on historical information/data, there are not be any separate delivery criteria necessary to receive the costs, and wherein if the costs are based on dynamic information/data, the delivery criteria based on the ability to synchronize the delivery with forecasted deliveries to the particular address or the surrounding addresses and includes specific delivery dates/times or ranges of dates/times.

In some embodiments, the memory stores computer-readable instructions that, when executed, cause the processor to consider information/data received from the customer, the information/data received from the customer comprising one or more of vacation schedules, alternate delivery locations, or requested delivery days of the week.

In some embodiments, the memory stores computer-readable instructions that, when executed, cause the processor to access raw information/data from at least one of customer profile data, historical address profile information/data or PLD data, and apply one or more business rules to determine one or more of (a) if synchronized delivery with one or more stop creator items are possible, (b) if costs are available, or (c) any criteria that must be met to receive the costs.

In some embodiments, the memory stores computer-readable instructions that, when executed, cause the processor to subsequent to the synchronization/density/cost analysis, compare the delivery criteria against the promised delivery dates, times, or time windows determined by the carrier system, and using the information/data, filter the cost results to meet the promised dates, times, and/or time windows

In some embodiments, the memory stores computer-readable instructions that, when executed, cause the processor to subsequent to the synchronization/density/cost analysis, communicate pick-up or delivery information/data to the one or more retailer systems for the particular address, the pick-up and/or delivery information/data communicated via an API, user interface, integrated software, pop-up windows or other communication protocol or path.

In some embodiments, the pick-up and/or delivery information/data being indicative of one or more of the costs, dates, times, or time windows, actual costs including discount amounts or discount percentages, or delivery criteria that must be met to receive the determined/identified cost.

In some embodiments, the pick-up and/or delivery information/data being indicative of a tendered date and one or more associated tender locations for the shipment to receive the cost, the tender locations being one or more fulfillment centers or drop-ship locations associated with the retailer, wherein the memory stores computer-readable instructions that, when executed, cause the processor to determine which tender locations to offer based on one or more of (a) volume in delivery lanes associated with the different locations, (b) time-in-transit, (c) proximity to delivery address, and (d) cost associated with the pick-up.

In some embodiments, the memory stores computer-readable instructions that, when executed, cause the processor to provide the pick-up or delivery information/data, the pick-up or delivery information/data comprising at least time-in-transit information/data, the pick-up or delivery information/data configured for use in calculating a tender date for the shipment for selected fulfillment centers or drop-ship locations.

In some embodiments, the memory stores computer-readable instructions that, when executed, cause the processor to periodically analyze the dynamic information/data to determine if new stop creator items are received, receive a repeat cost query after the retailer system has received the order to verify the cost, and in the event one or more new stop creator items are received between the initial determination and the receipt of the order resulting in a possible synchronization, or in the event one or more new stop creator items are received between the initial determination and the determined tender date, re-calculate the cost.

In some embodiments, the memory stores computer-readable instructions that, when executed, cause the processor to provide a unique identifier with the cost for use in identifying the shipment, wherein when the shipment is tendered to the carrier, capturing the unique identifier, and verify whether the shipment criteria has been met to receive the determined/identified cost.

In some embodiments, a computer program product for determining a delivery cost for an item to be delivered may be provided comprising at least one non-transitory computer-readable storage medium having computer-readable program code portions stored therein, the computer-readable program code portions comprising for receiving customer location information/data indicative of a customer location, the customer location information/data selected from the group consisting of entered information/data, customer profile information/data, or address information/data associated with a customer computing entity, and determining one or more time frames/periods from a plurality of carrier time frames/periods in which delivery of the item is available based on the customer location and a cost associated with each of the one or more time frames.

In some embodiments, the computer-executable program code instructions further comprise program code instructions for receiving a promised delivery date, wherein the determining of the one or more times frames/periods is dependent on the promised delivery date. In some embodiments, the computer-executable program code instructions further comprise program code instructions for determining, based on the customer location information/data, whether synchronized delivery with a stop creator ship is possible to increase delivery density or influence delivery parameter selections. In some embodiments, the computer-executable program code instructions further comprise program code instructions for normalizing the customer location information/data to determine a particular address. In some embodiments, the computer-executable program code instructions further comprise program code instructions for querying at least one of (a) a historical database, (b) a dynamic database, (c) a predictive database, (d) a combined database, and/or the like to determine if a cost is available.

In some embodiments, the computer-executable program code instructions further comprise program code instructions for in the event that only the historical database is queried, determining if costs are available for the particular address or surrounding address, the query result indicating one or more of (a) whether costs are available, (b) the type of costs including address match or nearby address match with an anticipated stop creator shipment, (c) actual costs, and (d) corresponding dates or times.

In some embodiments, the computer-executable program code instructions further comprise program code instructions for, in the event only the dynamic database is queried, determining if synchronized delivery with one or more stop creator items is possible and if costs are available for the particular address or the surrounding address, determining delivery criteria to be met to achieve synchronized delivery with the one or more stop creator items and to receive the costs and corresponding dates or times, the delivery criteria based on an ability to synchronize the delivery with forecasted deliveries to the particular address or the surrounding address and includes specific delivery dates or ranges of dates.

In some embodiments, the computer-executable program code instructions further comprise program code instructions for in the event a combined historical and dynamic database is queried, determining (a) if synchronized delivery with one or more stop creator items is possible and (b) if costs are available for the particular address or a surrounding address, determining delivery criteria to be met to achieve synchronized delivery and to receive the costs and corresponding dates or times, wherein if the costs are based on historical information/data, there are not be any separate delivery criteria necessary to receive the costs, and wherein if the costs are based on dynamic information/data, the delivery criteria based on the ability to synchronize the delivery with forecasted deliveries to the particular address or the surrounding addresses and includes specific delivery dates/times or ranges of dates/times.

In some embodiments, the computer-executable program code instructions further comprise program code instructions for considering information/data received from the customer, the information/data received from the customer comprising one or more of vacation schedules, alternate delivery locations, or requested delivery days of the week.

In some embodiments, the computer-executable program code instructions further comprise program code instructions for accessing raw information/data from at least one of customer profile data, historical address profile information/data or PLD data, and applying one or more business rules to determine one or more of (a) if synchronized delivery with one or more stop creator items are possible, (b) if costs are available, or (c) any criteria that must be met to receive the costs.

In some embodiments, the computer-executable program code instructions further comprise program code instructions for subsequent to the synchronization/density/cost analysis, comparing the delivery criteria against the promised delivery dates, times, or time windows determined by the carrier system, and using the information/data, filtering the cost results to meet the promised dates, times, and/or time windows.

In some embodiments, the computer-executable program code instructions further comprise program code instructions for subsequent to the synchronization/density/cost analysis, communicating pick-up or delivery information/data to the one or more retailer systems for the particular address, the pick-up and/or delivery information/data communicated via an API, user interface, integrated software, pop-up windows or other communication protocol or path.

In some embodiments, the pick-up and/or delivery information/data being indicative of one or more of the costs, dates, times, or time windows, actual costs including discount amounts or discount percentages, or delivery criteria that must be met to receive the determined/identified cost.

In some embodiments, the pick-up and/or delivery information/data being indicative of a tendered date and one or more associated tender locations for the shipment to receive the cost, the tender locations being one or more fulfillment centers or drop-ship locations associated with the retailer, wherein the computer-executable program code instructions further comprise program code instructions for determining which tender locations to offer based on one or more of (a) volume in delivery lanes associated with the different locations, (b) time-in-transit, (c) proximity to delivery address, and (d) cost associated with the pick-up.

In some embodiments, the computer-executable program code instructions further comprise program code instructions for providing the pick-up or delivery information/data, the pick-up or delivery information/data comprising at least time-in-transit information/data, the pick-up or delivery information/data configured for use in calculating a tender date for the shipment for selected fulfillment centers or drop-ship locations.

In some embodiments, the fulfillment center being selected based at least in part on the required delivery service level necessary to meet the delivery date and the availability of the purchased items at the fulfillment center.

In some embodiments, the computer-executable program code instructions further comprise program code instructions for periodically analyzing the dynamic information/data to determine if new stop creator items are received, receiving a repeat cost query after the retailer system has received the order to verify the cost, and in the event one or more new stop creator items are received between the initial determination and the receipt of the order resulting in a possible synchronization, or in the event one or more new stop creator items are received between the initial determination and the determined tender date, re-calculating the cost.

In some embodiments, the computer-executable program code instructions further comprise program code instructions for providing a unique identifier with the cost for use in identifying the shipment, wherein when the shipment is tendered to the carrier, capturing the unique identifier, and verifying whether the shipment criteria has been met to receive the determined/identified cost.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier system according to one embodiment of the present invention.

FIG. 3 is an exemplary schematic diagram of a user computing entity according to one embodiment of the present invention.

FIG. 4 is a flowchart illustrating operations and processes that can be used in accordance with various embodiments of the present invention.

FIGS. 5-14, 15A, 15B, 16, and 17 show exemplary input and output of various embodiments of the present invention.

FIG. 18 is a flowchart illustrating operations and processes that can be used in accordance with various embodiments of the present invention.

FIGS. 19A-19F show example graphical user interface displays that may be presented by various components of systems, in accordance with some embodiments.

FIG. 20 is a flowchart illustrating operations and processes that can be used in accordance with various embodiments of the present invention.

FIG. 21 shows an exemplary input and output of various embodiments of the present invention.

FIG. 22 is a flowchart illustrating operations and processes that can be used in accordance with various embodiments of the present invention.

FIG. 23 shows an example graphical user interface displays that may be presented by various components of systems, in accordance with some embodiments.

FIG. 24 is a flowchart illustrating operations and processes that can be used in accordance with various embodiments of the present invention.

FIGS. 25A-25J show example graphical user interface displays that may be presented by various components of systems, in accordance with some embodiments.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing entity, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

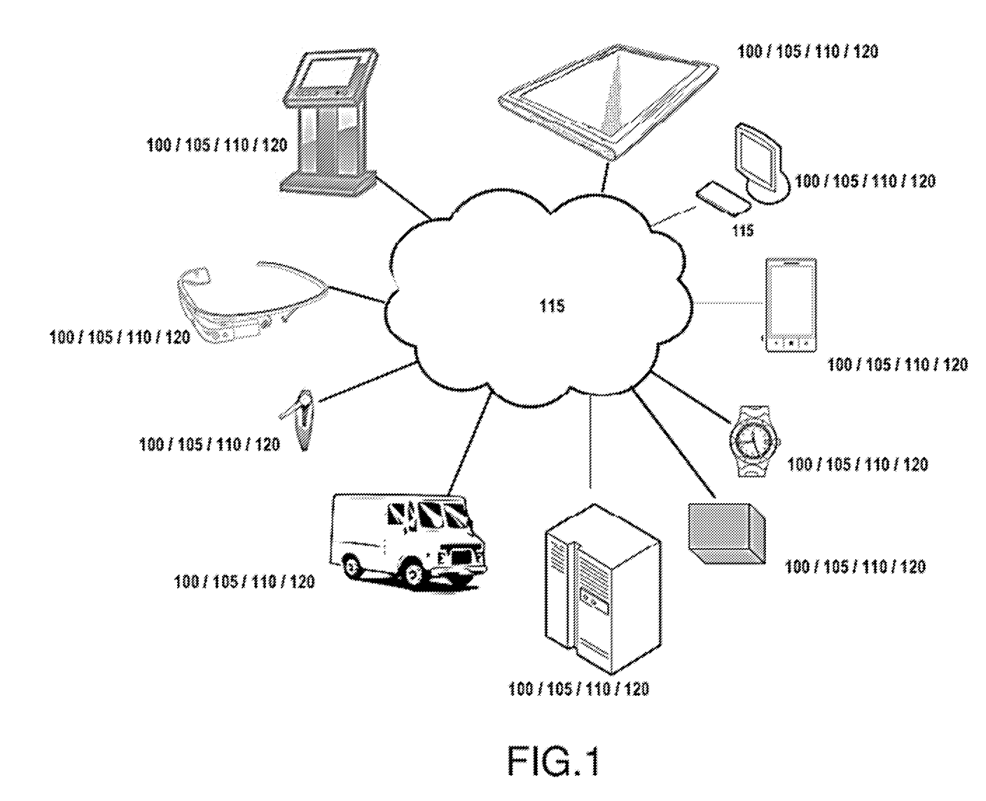

FIG. 1 provides an illustration of a system that can be used in conjunction with various embodiments of the present invention. As shown in FIG. 1, the system may include one or more carrier systems 100, one or more user computing entities 105, one or more consignee computing entities 110, and one or more networks 115, one or more consignor computing entities 120, and one or more retailer systems 125. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), and/or the like. Additionally, while FIG. 1 illustrates certain communication system entities as separate, standalone entities, the various embodiments are not limited to this particular architecture.

### 1. Exemplary Carrier System

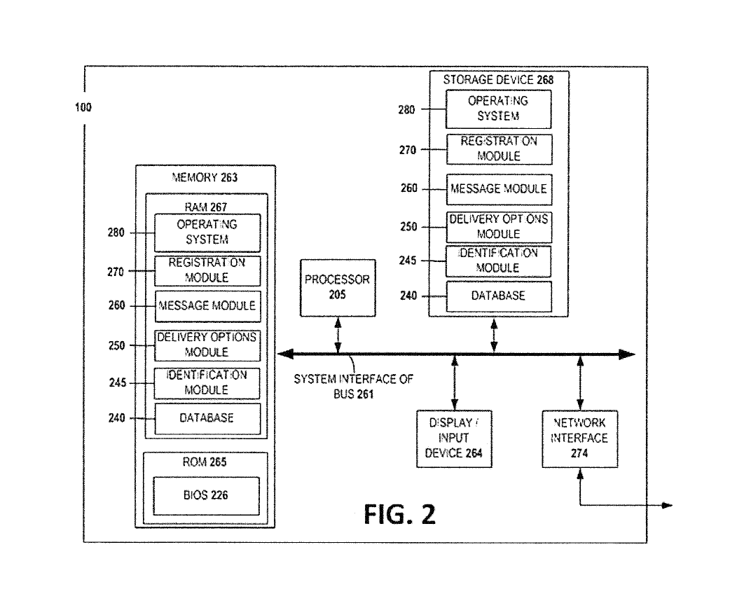

FIG. 2 provides a schematic of a carrier system 100 according to one embodiment of the present invention. A carrier may be a traditional carrier/transporter, such as UPS, FedEx, DHL, courier services, the United States Postal Service (USPS), Canadian Post, and/or the like. However, a carrier may also be a nontraditional carrier/transporter, such as Amazon, Google, Uber, ride-sharing services, crowd-source couriers/services, Macy's, and/or the like. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, vehicles, transportable items, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information/data, and/or similar terms used herein interchangeably.

The carrier system 100 may also comprise various other systems, such as an Address Matching System (AMS), an Internet Membership System (IMS), a Customer Profile System (CPS), a Package Center information/data System (PCIS), a Customized Pick-up and Delivery System (CPAD), a Web Content Management System (WCMS), a Notification Email System (NES), a Fraud Prevention System (FPS), and a variety of other systems and their corresponding components. The carrier system 100 may also be in communication with various payment networks/systems for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like.

As shown in FIG. 2, in one embodiment, the carrier system 100 may include or be in communication with one or more processing elements 205 (also referred to as processors, processing circuitry, and/or similar terms used herein interchangeably) that communicate with other elements within the carrier system 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the carrier system 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include an operating system 280, a registration module 270, a message module 260, a delivery options module 250, an identification module 245, a database 240, and/or the like. The terms database, database instance, database management system, and/or similar terms used herein interchangeably may refer to a structured collection of records or information/data that is stored in a computer-readable storage medium, such as via a relational database, hierarchical database, and/or network database.

In one embodiment, the carrier system 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the carrier system 100 with the assistance of the processing element 205 and operating system, such as a registration module, an alert module, a delivery options module, an identification module, a service schedule module, and/or the like.

As indicated, in one embodiment, the carrier system 100 may also include one or more communications interfaces 220 for communicating with various computing entities, such as by communicating data, content, information/data, and/or similar terms used herein interchangeably that can be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the carrier system 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, near field communication (NFC) protocols, Bluetooth protocols, wireless universal serial bus (USB) protocols, and/or any other wireless protocol.

Although not shown, the carrier system 100 may include or be in communication with one or more input elements, such as a keyboard input, a mouse input, a touch screen/display input, motion input, movement input, audio input, pointing device input, joystick input, keypad input, and/or the like. The carrier system 100 may also include or be in communication with one or more output elements (not shown), such as audio output, video output, screen/display output, motion output, movement output, and/or the like.

The carrier system 100 may also be configured to receive, effect, or initiate payments. Payments may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, Bluetooth low energy (BLE), and various other contactless payment systems. Further, such payment technologies may include PayPal Beacon, Booker, Erply, Leaf, Apple Pay, Leapset, Micros, PayPal Here, Revel, ShopKeep, TouchBistro, Vend, and/or the like.

As will be appreciated, one or more of the carrier system's 100 components may be located remotely from other carrier system 100 components, such as in a distributed system. Furthermore, one or more of the components may be combined and additional components performing functions described herein may be included in the carrier system 100. Thus, the carrier system 100 can be adapted to accommodate a variety of needs and circumstances. As will be recognized, these architectures and descriptions are provided for exemplary purposes only and are not limiting to the various embodiments.

### 2. Exemplary User Computing Entity

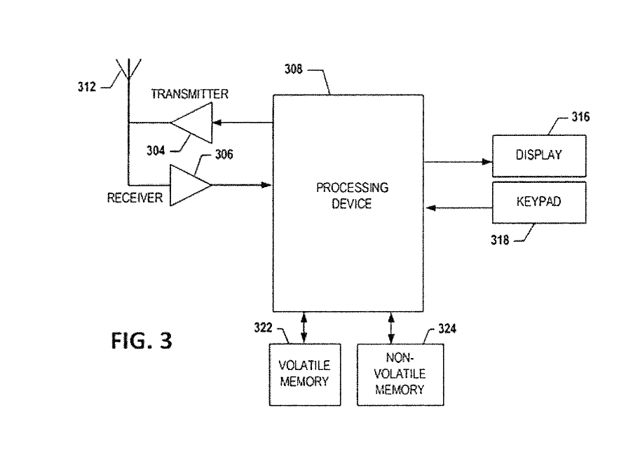

A user may be an individual, a family, a company, an organization, an entity, a department within an organization, a representative of an organization and/or person, and/or the like. To do so, a user may operate a user computing entity 105 that includes one or more components that are functionally similar to those of the carrier system 100. FIG. 3 provides an illustrative schematic representative of a user computing entity 105 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, televisions, vehicles, transportable items, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 105 can be operated by various parties, including carrier or retailer employees or representatives. As shown in FIG. 3, the user computing entity 105 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information/data in accordance with air interface standards of applicable wireless systems. In this regard, the user computing entity 105 may be capable of operating with one or more air interface standards, communication protocols, modulation types, and access types. More particularly, the user computing entity 105 may operate in accordance with any of a number of wireless communication standards and protocols, such as those described above with regard to the carrier system 100. In a particular embodiment, the user computing entity 105 may operate in accordance with multiple wireless communication standards and protocols, such as UMTS, CDMA2000, 1 xRTT, WCDMA, TD-SCDMA, LTE, E-UTRAN, EVDO, HSPA, HSDPA, Wi-Fi, WiMAX, UWB, IR, NFC, Bluetooth, USB, and/or the like. Similarly, the user computing entity 105 may operate in accordance with multiple wired communication standards and protocols, such as those described above with regard to the carrier system 100 via a network interface 320.

Via these communication standards and protocols, the user computing entity 105 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 105 can also download changes, add-ons, and updates, for instance, to its firmware, software (e.g., including executable instructions, applications, program modules), and operating system.

According to one embodiment, the user computing entity 105 may include a location determining aspects, device, module, functionality, and/or similar words used herein interchangeably. For example, the user computing entity 105 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data can be determined by triangulating the user computing entity's 105 position in connection with a variety of other systems, including cellular towers, Wi-Fi access points, and/or the like. Similarly, the user computing entity 105 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine/identify the location of someone or something to within inches or centimeters.

The user computing entity 105 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the user computing entity 105 to interact with and/or cause display of information/data from the carrier system 100, as described herein. The user input interface can comprise any of a number of devices allowing the user computing entity 105 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 105 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 105. As indicated, this may include a user application that is resident on the entity or accessible through a browser or other user interface for communicating with the carrier system 100 and/or various other computing entities.

In another embodiment, the user computing entity 105 may include one or more components or functionality that are the same or similar to those of the carrier system 100, as described in greater detail above. As will be recognized, these architectures and descriptions are provided for exemplary purposes only and are not limiting to the various embodiments.

### 3. Exemplary Consignee Computing Entity

The consignee computing entities 110 may each include one or more components that are functionally similar to those of the carrier system 100 and/or user computing entity 105. For example, in one embodiment, each of the consignee computing entities may include: (1) a processor that communicates with other elements via a system interface or bus; (2) a user interface; (3) transitory and non-transitory memory; and (4) a communications interface. As noted, the consignee computing entity 110 may comprise a user interface (that can include a display device/input device coupled to a processing element) and/or a user input interface (coupled to a processing element). For example, the user interface may be a carrier or retailer application, browser, user interface, dashboard, webpage, and/or similar words used herein interchangeably executing on and/or accessible via the consignee computing entity 110 to interact with and/or cause display of information/data from the carrier system 100, as described herein. These architectures are provided for exemplary purposes only and are not limiting to the various embodiments. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, televisions, vehicles, transportable items, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. A customer may refer to either a consignor (e.g., a party shipping an item via carrier) or a consignee (e.g., a party receiving an item from a carrier). In the returns context, a consignee who received an item can become a consignor when returning an item.

### 4. Exemplary Consignor Computing Entity

The consignor computing entities 120 may each include one or more components that are functionally similar to those of the carrier system 100, user computing entity 105, and/or consignee computing entity 110. For example, in one embodiment, each of the consignor computing entities may include: (1) a processor that communicates with other elements via a system interface or bus; (2) a user interface; (3) transitory and non-transitory memory; and (4) a communications interface. As noted, the consignor computing entity 120 may comprise a user interface (that can include a display device/input device coupled to a processing element) and/or a user input interface (coupled to a processing element). For example, the user interface may be a carrier or retailer application, browser, user interface, dashboard, webpage, and/or similar words used herein interchangeably executing on and/or accessible via the consignor computing entity 120 to interact with and/or cause display of information/data from the carrier system 100, as described herein. These architectures are provided for exemplary purposes only and are not limiting to the various embodiments. A customer may refer to a consignor (e.g., a party shipping an item via carrier), a consignee (e.g., a party receiving an item from a carrier) a third party, and/or the like. In the returns context, a consignor who shipped an item can become a consignee when an item is being returned.

### 5. Exemplary Retailer System or Third Party System

The retailer system/third party system 125 may each include one or more components that are functionally similar to those of the carrier system 100, user computing entity 105, consignee computing entity 110, and/or consignor computing entity 120. For example, in one embodiment, the retailer system/third party system 125 may include: (1) a processor that communicates with other elements via a system interface or bus; (2) a user interface; (3) transitory and non-transitory memory; and (4) a communications interface. As noted, retailer system/third party system 125 may provide a user interface, such as a carrier or retailer application, browser, user interface, dashboard, webpage, and/or similar words used herein interchangeably executing on and/or accessible to interact with and/or cause display of information/data from the retailer system/third party system 125 and/or carrier system 100, as described herein. These architectures are provided for exemplary purposes only and are not limiting to the various embodiments.

### III. EXEMPLARY SYSTEM OPERATION

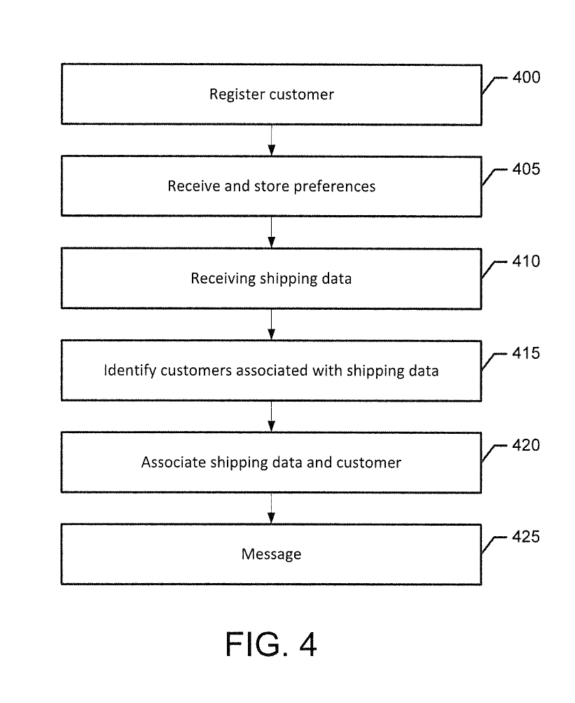

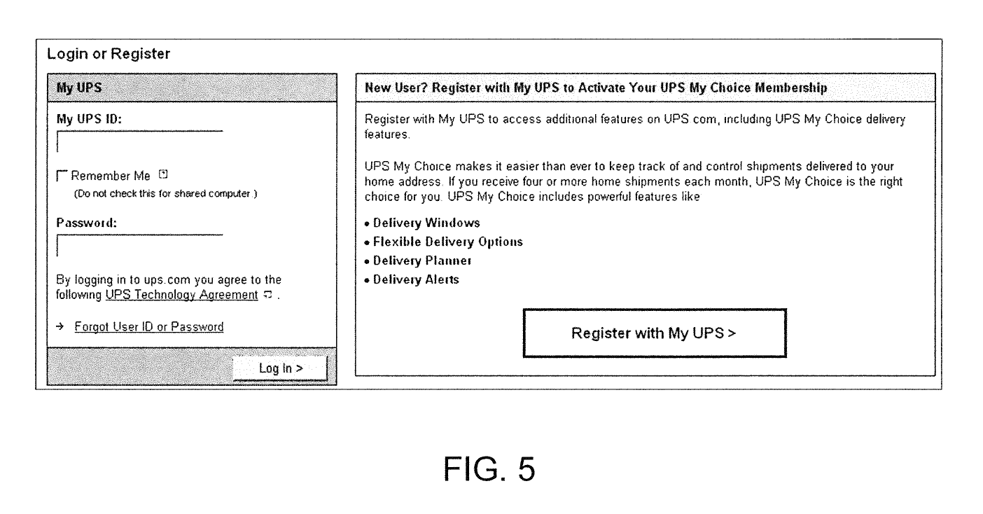

Reference will now be made to FIGS. 4-14, 15A, 15B, 16-18, 19A-19E, 20-24, and 25A-25J. FIGS. 4, 18, 20, 22, and 24 are flowcharts illustrating operations and processes that may be performed for determining delivery windows for item delivery based on customer location and/or item location. FIGS. 5-14, 15A, 15B, 16-17, 19A-19E, 21, 23, and 25A-25J show exemplary input and output for determining delivery windows for item delivery based on customer location and/or item location. As will be recognized, the following description and figures describe integrated approaches for interacting with customers. That is, certain of the following embodiments may include an integrated solution through which a retailer system/third party system 125 may provide functionality described in the context of the carrier system 100 and/or the carrier system 100 may provide functionality described in the context of the retailer system/third party system 125.

### 1. Registration

In one embodiment, as indicated in Block 400 of FIG. 4, the process may begin with the enrollment/registration of one or more customers (e.g., consignors and/or consignees) for one or more accounts, services, subscriptions, programs, and/or similar words used herein interchangeably. In one embodiment, an account may be an account for wireless services with wireless service providers, such as an account with China Mobile, Vodafone, Telefonica, T-Mobile, Verizon, AT&T, Qtel, China Unicom, Airtel, Etisalat, and/or the like. An account may be a business or personal social media account, such as an account with Facebook, LinkedIn, Google+, Pinterest, Microsoft Yammer, WMWare Socialcast, IBM Connections, SalesForce Chatter, Twitter, KaKao Talk, WhatsApp, WeChat, Yo, Etsy, Twitter, Instagram, Vine, Snapchat, YouTube, Qzone, Sina Weibo, Tumblr, LINE, WeChat, and/or the like. An account may be a gaming account, such as an account with Ubisoft, Mojang, Blizzard, Capcom, Deepsilver, Zombie Studios, Epic Games, Valve, Carbon Games, Digital Extremes, Klei Entertainment, Riot Games, Frozenbyte, Nvidia Shield, Ouya, Xbox, Xbox 360, Xbox One, Wii, Wii U, PlayStation, PlayStation 2, PlayStation PlayStation 3, PlayStation 4, 3DO, GameCube, Genesis, Intellivision, Nintendo 64, and/or the like. An account may be an entertainment account, such as an account with AppleTV, Apple, Dish, Amazon Digital Services, AT&T U-verse, DIRECT TV, Google Play, QVC, and/or the like. An account may be for retail services, such as an account with amazon.com, macys.com, dell.com, walmart.com, apple.com, staples.com, amazon.com, bestbuy.com, costco.com, alibaba.com, ebay.com, netflix.com, hulu.com, sears.com, and/or the like. An account may be for payment services, such as PayPal, Google Wallet, Amazon Payments, Booker, Erply, Leaf, Leapset, Micros, Revel, ShopKeep, TouchBistro, Vend, and/or the like. An account may be for pickup, delivery, and/or returns services with a carrier/transporter entity, such as an account with UPS for My Choice and/or the like. As will be recognized, a variety of different accounts can be used to adapt to various needs and circumstances.

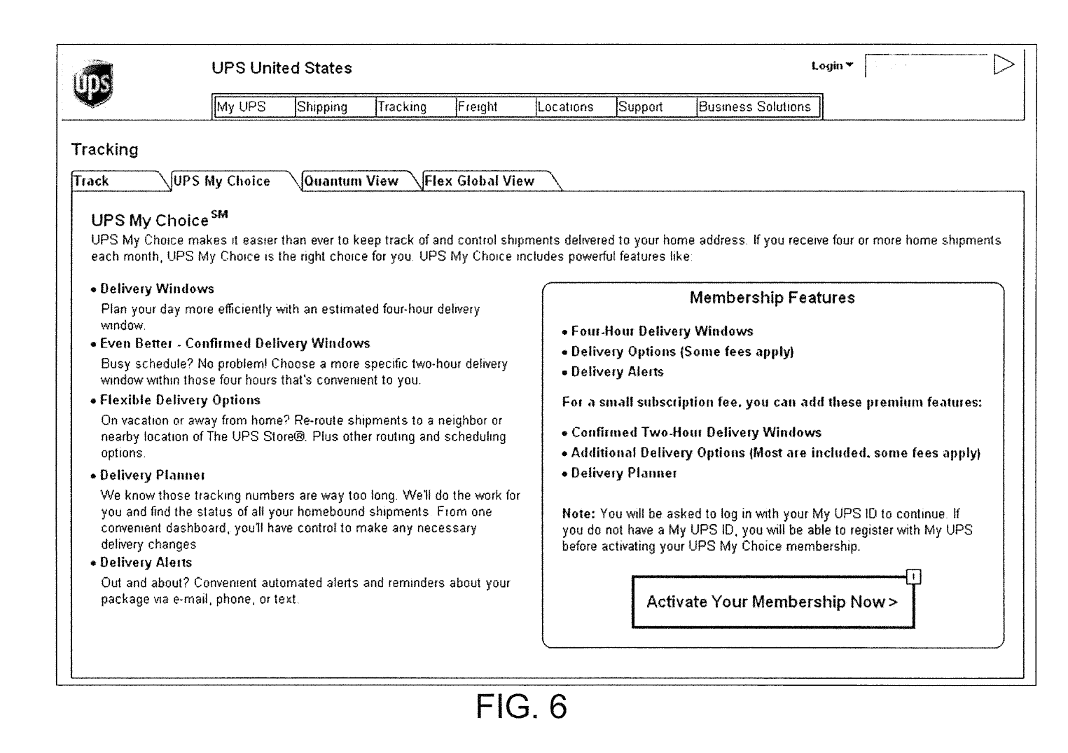

In one embodiment, to register, a customer (e.g., a customer or customer representative operating a consignee computing entity 110 or consignor computing entity 120) may access a webpage, application, dashboard, browser, or portal of an appropriate party. For instance, as shown in FIGS. 5 and 6, the carrier system 100 and/or retailer system/third party system 125 may provide an interface that provides the customer with an option of logging into a customer account or enrolling/registering for a customer pick-up, delivery, and/or returns program with the carrier and/or for an account, subscription, or program with a retailer. In the context of a retailer, the registration may be automatic, as part of the checkout process, an opt-in option provided by the retailer, and/or performed using various other approaches and techniques.

In one embodiment, as part of the enrollment/registration process, the customer (e.g., operating a consignee computing entity 110 or consignor computing entity 120) may be requested to provide customer information/data (e.g., including biographic information/data, geographic information/data, and/or the like) by the carrier system 100 and/or retailer system/third party system 125 (e.g., via the registration module). Such information/data may be manually input by a customer; automatically provided by a retailer (e.g., via a retailer system 100); automatically provided by allowing access to other accounts, such as Amazon.com, Facebook, Gmail, Twitter, PayPal, and/or the like; automatically collected by various computing entities; and/or combinations thereof and other techniques and approaches. For instance, the information/data may include the customer's name, such as a first name, a last name, a company name, an entity name, and/or an organization name. The customer (e.g., consignor or consignee) may also provide any aliases associated with the customer. For instance, if the customer (e.g., consignor or consignee) were an individual named Joseph Brown, the customer (e.g., consignor or consignee) may provide Joe Brown or Joey Brown as aliases.

The information/data may include also one or more customer locations. A customer location may be any identifiable location, such as one or more addresses, delivery locations, parking locations, lockers, access points, longitude and latitude points, geocodes, stops (e.g., pick up stops, delivery stops, vehicle visits, stops) geofenced areas, geographic areas, landmarks, buildings, bridges, and/or other identifiable locations. For example, a customer location may be a residential location, such as one or more homes, one or more mobile homes, one or more apartments, one or more apartment buildings, one or more condominiums, one or more townhomes, one or more points at such locations, and/or the like. The customer location may also be any specific location at a residential location, e.g., (e.g., front door of a residence, side door of a residence, and/or the like). A customer location may also be a commercial location, such as one or more stores in a mall, one or more office buildings, one or more office parks, one or more offices of an apartment complex, one or more garages, one or more warehouses, one or more restaurants, one or more floors or offices of a building, one or more stores, one or more retail locations, one or more points at such locations, and/or the like. The customer location may also be any specific location at a commercial location, e.g., (e.g., front door of a commercial, dock of a commercial location, and/or the like). As will be recognized, a variety of approaches and techniques can be used to adapt to various needs and circumstances.

In one embodiment, the customer location may be one or more physical addresses associated with the customer (e.g., street address, city, state, postal code, and/or country). For instance, Joseph Brown's primary residential address of 105 Main Street, Atlanta, Ga. 30309, USA, may be provided to the carrier system 100 and/or retailer system/third party system 125. Further, one or more secondary residential addresses may also be provided to the carrier system 100 and/or retailer system/third party system 125 for association with Mr. Brown's account and profile, such as 71 Lanier Islands, Buford, Ga. 30518, USA. As will be recognized, the residential addresses may include weekend residences, family member residences visited by the customer, and/or the like. Additionally, the customer (e.g., consignor or consignee) may also provide one or more business addresses associated with the customer (e.g., street address, city, state, postal code, and/or country) to the carrier system 100 and/or retailer system/third party system 125. For example, Mr. Brown may have a primary business address of 1201 W Peachtree, Atlanta, Ga. 30309, USA. One or more secondary business addresses may also be provided to the carrier system 100 and/or retailer system/third party system 125 for association with Mr. Brown's account and profile, such as 101 South Tryon Street, Charlotte, N.C. 28280, USA; 950 F Street, NW, Washington, D.C. 20004, USA; and 90 Park Avenue, New York, N.Y. 10016, USA. As will be recognized, the business addresses may include various office locations for a single enterprise, multiple office locations for various enterprises, and/or the like. As will be recognized, the customer (e.g., consignor or consignee) may provide other biographic and/or geographic information/data to adapt to various needs and circumstances.

In one embodiment, in addition to receiving the necessary biographic and/or geographic information/data from the customer, the carrier system 100 and/or retailer system/third party system 125 may perform one or more validation processes and operations, verification processes and operations, fraud processes and operations, and/or similar words used herein interchangeable. As will be recognized, these operations and processes may include the use of various techniques and approaches that require using authenticated links, signup codes, time constraints, and/or other parameters and features for registering/enrolling customers into the customer pick-up, delivery, and/or returns program with a carrier and/or for an account, subscription, or program with a retailer. In embodiments in which the retailer system/third party system 125 provides information/data for registration to the carrier system 100, the retailer system/third party system 125 can indicate a customer as being authenticated, and thus one or more of the validation and/or or fraud processes and operations can be bypassed, if desired. As will be recognized, a variety of other approaches and techniques can be used to adapt to various needs and circumstances.

The carrier system 100 and/or retailer system/third party system 125 may determine/identify whether the primary address (and/or other addresses such as, for example, a virtual address, e-mail address, text message ID, a global address, for example, assigned by a global address system, and/or the like) in the specified country or postal code is eligible for a customer pick-up, delivery, and/or returns programs and/or carrier, retailer and/or third party accounts. The carrier system 100 and/or retailer system/third party system 125 may also determine/identify whether the primary address (and/or other addresses) is valid, e.g., by passing the primary address through one or more address cleansing or standardization systems. The carrier system 100 and/or retailer system/third party system 125 may perform a variety of fraud prevention measures as well, such as determining whether the customer (e.g., consignor or consignee) or one of the customer's addresses has been “blacklisted” from customer pick-up, delivery, and/or returns programs and/or retailer accounts. As will be recognized, a variety of other approaches and techniques can be used to adapt to various needs and circumstances.

In one embodiment, the carrier system 100 and/or retailer system/third party system 125 may create a customer profile for the customer via the enrollment/registration process. Accordingly, the carrier system 100 and/or retailer system/third party system 125 may create, store, and/or have access to various customer profiles (e.g., via database) and/or information/data associated with the customer profiles. In addition to at least the information/data described above, a customer profile may include one or more corresponding usernames and passwords (e.g., credentials) for accessing accounts associated with the carrier and/or retailer. For example, the carrier system 100 can store and use a customer's retailer credentials for access to the carrier system 100, and/or the retailer system/third party system 125 can store and use a customer's carrier credentials for access to the retailer system/third party system 125.

In one embodiment, in addition to the physical addresses, the customer (e.g., operating a customer computing entity 110/120) may also input, request, or be automatically generated and assigned a “virtual address.” The virtual address can be a combination of alphanumeric characters to identify a customer or customer profile. The virtual address can be stored by the carrier system 100 and/or retailer system/third party system 125 in association with the customer's profile. For example, Joseph Brown (e.g., operating a customer computing entity 110/120) may input a request for a unique virtual address such as BigBrown8675309 or any other unique virtual address. In another embodiment, the carrier system 100 and/or retailer system/third party system 125 may automatically generate and assign a unique virtual address for the customer, such as assigning virtual address 1XR457 to Joseph Brown. Such virtual addresses can be used by customers who do not want to (a) provide their physical addresses to third parties, (b) have their physical addresses printed on labels placed on the exterior of items, and/or (c) the like. For instance, this may enable a consignor to ship a package using only BigBrown8675309 or 1XR457 as the destination address (e.g., virtual address) using the appropriate carrier. Upon induction of the package into the carrier's transportation and logistics network, the carrier personnel can read (e.g., manually or with the aid of a device) the virtual address on the item (e.g., BigBrown8675309 or 1XR457), look up the appropriate physical delivery address for the item based on the consignee's profile (e.g., search for the customer profile associated with the virtual address), and route the item accordingly (including the use of automatic service schedules). In certain embodiments, the item may be routed only using the virtual address. That is, each time the item is handled by carrier personnel, a user computing entity 105 (in communication with the carrier system 100 and/or retailer system/third party system 125) operated by the carrier personnel can cause display of the appropriate handling or routing instructions while masking the actual physical delivery address. In other embodiments, however, once the item with the virtual address is inducted into the carrier's transportation and logistics network, carrier personnel may place a label on the item that indicates the physical delivery address (e.g., based on an address associated with the profile and/or automatic service schedule). Such virtual address concepts are disclosed in U.S. Pat. No. 8,108,321, which is hereby incorporated in its entirety by reference. Both physical addresses and virtual addresses may be referred to herein interchangeably as “addresses.”

In addition to the virtual address, the carrier system 100 and/or retailer system/third party system 125 may also generate and store an internal customer identifier in association with the customer profile (e.g., tokenized). In one embodiment, a customer identifier may be used to uniquely identify a customer profile. In another embodiment, a customer identifier may be used to uniquely identify a given address (e.g., physical address or virtual address) associated with a customer profile. In such an embodiment, if a customer profile is associated with four addresses, the carrier system 100 and/or retailer system/third party system 125 may generate and store (e.g., tokenize) four customer identifiers in association with the customer profile (or use one customer identifier for all the addresses for the customer). The customer identifier may also be stored in association with shipping information/data for an item to associate the item (and its shipping information/data) with the (a) correct customer (e.g., customer profile) and/or (b) correct address for a customer.

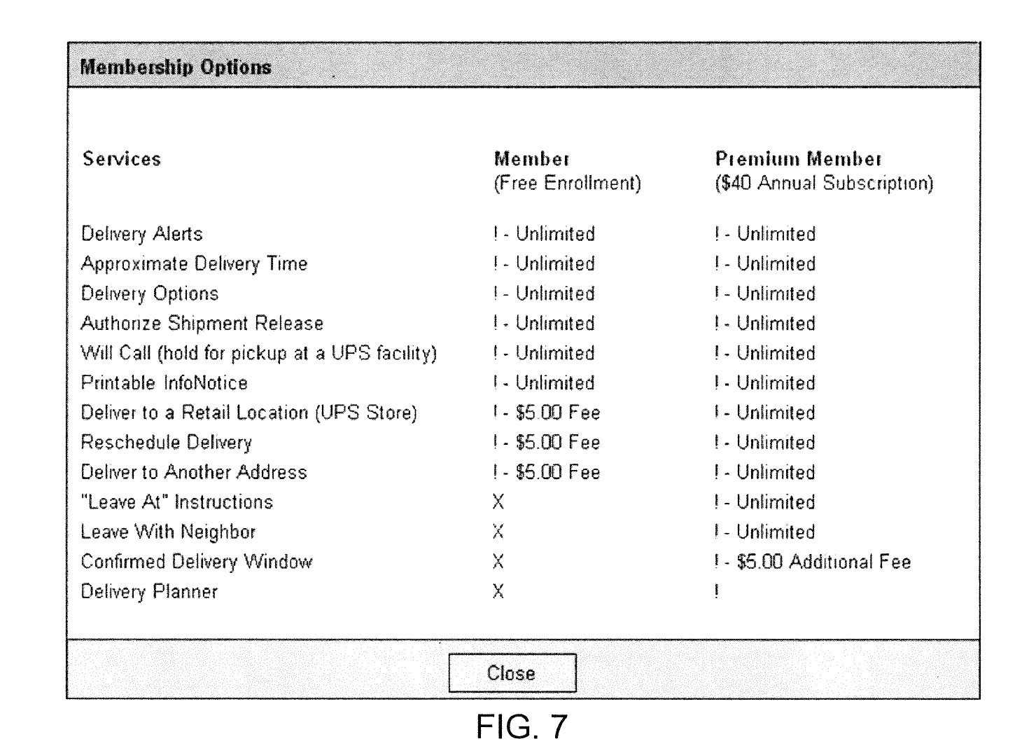

In one embodiment, a customer profile may correspond to one or more customer pick-up, delivery, and/or returns programs and/or retailer and/or third party accounts, subscriptions, and/or programs. For instance, a customer (e.g., operating a customer computing entity 110/120) may subscribe to a specific customer pick-up, delivery, and/or returns program and/or retailer accounts, subscriptions, and/or programs. In one embodiment, there may be several customer pick-up, delivery, and/or returns programs and/or retailer accounts, subscriptions, and/or programs from which to choose, such as free programs or accounts and premium programs or accounts (e.g., Amazon Prime). Each customer pick-up, delivery, and/or returns program and/or retailer account, subscription, and/or program may have different benefits, such as those shown in FIG. 7 and Table 1 below.

TABLE 1
Membership Options

| | Member | Premium Member |
|---|---|---|
| | (Free | ($40 Annual |
| Services | Enrollment) | Subscription) |
| Delivery Alerts | ! - Unlimited | ! - Unlimited |
| Approximate Deliver Time | ! - Unlimited | ! - Unlimited |
| Delivery Options | ! - Unlimited | ! - Unlimited |
| Authorize Shipment Release | ! - Unlimited | ! - Unlimited |
| Will Call (hold for pickup | ! - Unlimited | ! - Unlimited |
| at a UPS facility) | | |
| Printable InfoNotice | ! - Unlimited | ! - Unlimited |
| Deliver to a Retail Location | ! - $5.00 Fee | ! - Unlimited |
| (UPS Store) | | |
| Reschedule Delivery | ! - $5.00 Fee | ! - Unlimited |
| Deliver to Another Address | ! - $5.00 Fee | ! - Unlimited |
| “Leave At” instructions | X | ! - Unlimited |
| Leave With Neighbor | X | ! - Unlimited |
| Confirmed Delivery Window | X | ! - $5.00 Additional Fee |
| Delivery Planner | X | ! |

Close

As shown in Table 1 above and in FIG. 7 for illustrative purposes, the free customer pick-up, delivery, and/or returns program and the premium customer pick-up, delivery, and/or returns program may have different benefits. For example, the free customer pick-up, delivery, and/or returns program may allow customers to have access to certain features, e.g., pick-up and delivery alerts, approximate pick-up and delivery times, change pick-up and delivery options, electronically authorize the release of an item, and/or route items to will call. Similarly, the premium customer pick-up, delivery, and/or returns program (e.g., requiring a fee) may allow customers to have access to certain features in addition to those provided via the free customer pick-up, delivery, and/or returns program, e.g., route items to other retail locations, reschedule pick-ups and deliveries, request that items be delivered to another address, and/or provide instructions for pick-up or delivery. Payments for such fees may be in a variety of forms, such as via debit card, credit card, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. As will be recognized, these features are provided for illustrative purposes and are not limiting to embodiments of the present invention. Moreover, a variety of other approaches and techniques can be used to adapt to various needs and circumstances.

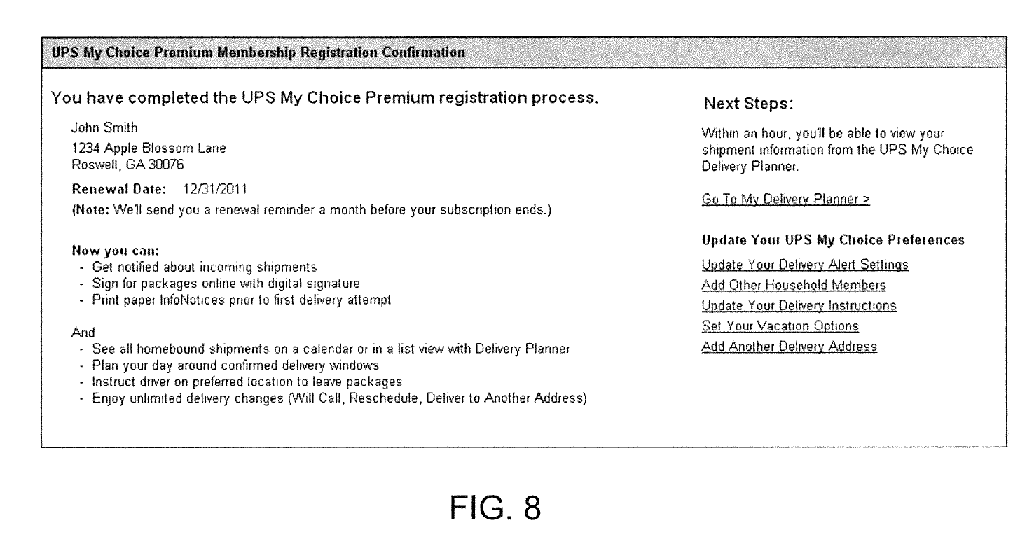

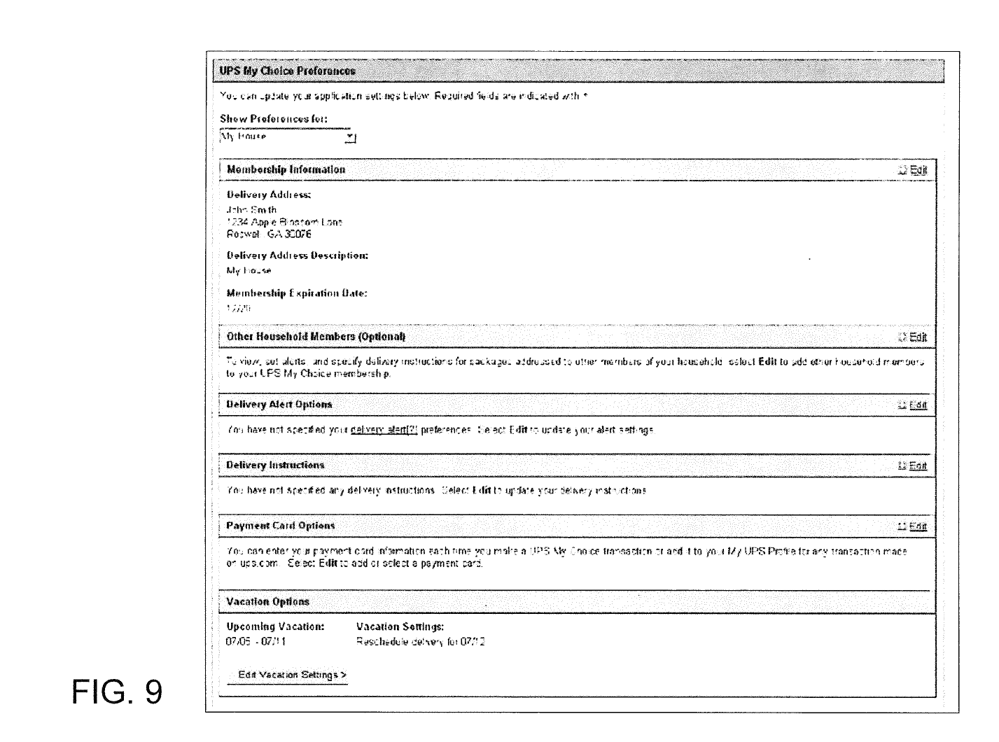

In one embodiment, once a customer profile has been created by the carrier system 100 and/or retailer system/third party system 125, the customer (e.g., operating a customer computing entity 110/120) can provide various preferences, options, and features associated with the accounts, subscriptions, and/or programs to the carrier system 100 and/or retailer system/third party system 125 via an interface (Block 405 of FIG. 4), for example. For instance, as shown in FIGS. 8 and 9, the customer (e.g., operating a customer computing entity 110/120) can provide a variety of preferences, such communication preferences, service schedule preferences, delivery preferences, delivery options, and/or delivery instructions. The customer (e.g., operating a customer computing entity 110/120) may also update any information/data through the appropriate interface (e.g., browser, dashboard, webpage, application).

### 2. Customer and Item Matching

In one embodiment, as part of the online shopping experience, the retailer system/third party system 125 may send a request to the carrier system 100 to determine/identify whether the customer is enrolled in one or more customer pick-up, delivery, and/or returns program. As discussed further below, the request may comprise customer information/data and/or shipping information/data that includes customer information/data. In another embodiment, once a customer (e.g., consignor or consignee) profile has been created by the carrier system 100 and/or retailer system/third party system 125, one or more items to be picked up from, delivered to, and/or returned from the customer can be identified as corresponding to the customer. By identifying items or profiles corresponding to the customer, the carrier system 100 and/or retailer system/third party system 125 can provide the customer with access to various features of the customer pick-up, delivery, and/or returns program and/or can make various determinations. As will be recognized, an item may be any tangible and/or physical object. In one embodiment, an item may be or be enclosed in one or more packages, parcels, bags, containers, loads, crates, items banded together, vehicle parts, pallets, drums, the like, and/or similar words used herein interchangeably. Such items may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. In this regard, in some example embodiments, an item may communicate send “to” address information/data, received “from” address information/data, unique identifier codes, and/or various other information/data. In one embodiment, each item may include an item/shipment identifier, such as an alphanumeric identifier. Such item/shipment identifiers may be represented as text, barcodes, tags, character strings, Aztec Codes, MaxiCodes, information/data Matrices, Quick Response (QR) Codes, electronic representations, and/or the like. A unique item/shipment identifier (e.g., 123456789) may be used by the carrier to identify and track the item as it moves through the carrier's transportation network. Further, such item/shipment identifiers can be affixed to items by, for example, using a sticker (e.g., label) with the unique item/shipment identifier printed thereon (in human and/or machine readable form) or an RFID tag with the unique item/shipment identifier stored therein.

In one embodiment, the carrier system 100 and/or retailer system/third party system 125 may store an item/shipment identifier in association with shipping information/data for the item. The shipping information/data may include information/data about the item, such as delivery service level. For example, the delivery service level may be Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like. The shipping information/data may include customer information/data about the party shipping the item (e.g., customer information/data, consignor information/data), such as the party's address, the party's phone number, the party's return address, the party's name, and/or the like. The shipping information/data may also include customer information/data about the customer to whom the item is to be delivered (e.g., customer information/data, consignee information/data), such as the customer's physical address or location (e.g., delivery point/location), the customer's virtual address, the customer's phone number, the customer's name, and/or the like. As will be recognized, the terms delivery point/location are intended encompass any identifiable location, including residences, commercial locations, stores, vehicles, boats, landmarks, and/or the like.

In one embodiment, the shipping information/data may include information/data about the item itself and any tracking information/data. The tracking information/data may reflect the item's movement in the carrier's transportation and logistics network, including an expected pick-up or delivery date and time. To reflect the item's movement, an item/shipment identifier associated with the item may be scanned or otherwise electronically read at various points as the item is transported through the carrier's transportation and logistics network. For example, the item/shipment identifier may be automatically scanned by a barcode or MaxiCode device, an RFID interrogator, by a camera controller, or by a carrier employee using a handheld device (e.g., user computing entity 105). In one embodiment, each time the item/shipment identifier is scanned or read, an appropriate device can transmit the item/shipment identifier and other appropriate information/data (e.g., location and time of the scan or reading) to the carrier system 100 and/or retailer system/third party system 125. The carrier system 100 and/or retailer system/third party system 125 can then receive and use the information/data to track the item as it is transported though the carrier's transportation and logistics network and update the shipping information/data accordingly.

In one embodiment, the carrier system 100 and/or retailer system/third party system 125 can use customer information/data and/or shipping information/data that includes customer information/data to identify one or more customer profiles (e.g., via the identification module). As described, each customer profile may include one or more physical addresses or virtual addresses associated with the customer. Thus, when the carrier system 100 and/or retailer system/third party system 125 receives customer information/data and/or shipping information/data (Block 410 of FIG. 4), the carrier system 100 and/or retailer system/third party system 125 can determine/identify whether the customer information/data and/or shipping information/data corresponds to any customers enrolled/registered for a customer pick-up, delivery, and/or returns program and/or an account, subscription, or program with a retailer. In particular, the carrier system 100 and/or retailer system/third party system 125 can use the physical delivery address or the virtual address of the customer information/data and/or shipping information/data to identify (a) any customer profiles with a substantially similar physical delivery address or (b) a customer profile that matches the virtual address (Block 415 of FIG. 4). For example, if the customer information/data and/or shipping information/data indicates that the physical delivery address of the intended recipient is 105 Main St., Atlanta, Ga. 30309, the carrier system 100 and/or retailer system/third party system 125 may identify Joseph Brown's customer profile even though the address in Joseph Brown's profile is 105 Main Street, Atlanta, Ga. 30309, USA. In other words, in making such determinations, the carrier system 100 and/or retailer system/third party system 125 can accommodate variations for a given address. As will be recognized, the carrier system 100 and/or retailer system/third party system 125 may be configured to compensate for various discrepancies. Other unique information/data can also be used for the same purpose, such as email addresses, phone numbers, usernames, and/or the like.

In one embodiment, as a secondary measure for matching addresses to customer profiles, the carrier system 100 and/or retailer system/third party system 125 can use the first, last, and middle names in the customer information/data and/or shipping information/data to confirm that the identified customer profile is correct. To do so, the carrier system 100 and/or retailer system/third party system 125 may compare one or more portions of a name from the customer information/data and/or shipping information/data to the primary name and/or any aliases in the identified customer profile. If the names are substantially similar, the carrier system 100 and/or retailer system/third party system 125 can confirm that the identified customer profile is correct. By way of example, if the customer information/data and/or shipping information/data indicates the name Joe Brown and Joseph Brown listed Joe as a first name alias, the carrier system 100 and/or retailer system/third party system 125 could confirm Joseph Brown's customer profile. As will be recognized, a variety of other approaches and techniques can be used to identify a customer profile corresponding to the customer information/data and/or shipping information/data.

In another embodiment, the carrier system 100 and/or retailer system/third party system 125 can use the virtual address of the intended recipient (e.g., consignee or customer) in the customer information/data and/or shipping information/data to identify the appropriate customer profile (Block 415 of FIG. 4). For example, if the customer information/data and/or shipping information/data indicates that the virtual address is BigBrown8675309 (or 1XR457), for example, the carrier system 100 and/or retailer system/third party system 125 may identify Joseph Brown's customer profile. As will be recognized, a variety of other approaches and techniques can be used to adapt to various needs and circumstances.

In one embodiment, after identifying the appropriate customer profile based on the customer information/data and/or shipping information/data for an item to be or being transported by the carrier, the carrier system 100 and/or retailer system/third party system 125 can associate the shipping information/data with the customer profile (Block 420 of FIG. 4). In certain embodiments, this may include appending the shipping information/data with the appropriate customer identifier. For instance, the shipping information/data for all shipments corresponding to Joseph Brown's customer profile may be appended with the customer identifier created for Joseph Brown. In various embodiments, using this approach allows items (and their shipping information/data) to be linked to appropriate customer profiles. Thus, when Joseph Brown accesses his account, he can view all of his shipments (e.g., those shipments with shipping information/data appended with his customer identifier (or other identifier)). Similarly, any actions for an item or customer can be passed to the shipping information/data for the item (including carrying out automatic service schedules).

### 3. Item Tracking

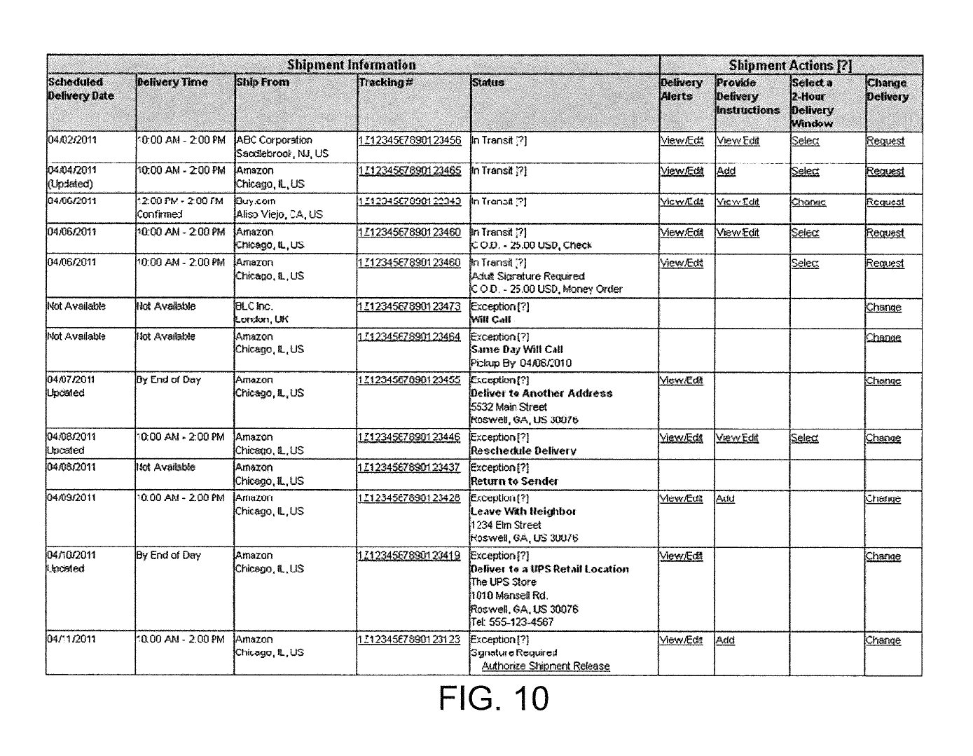

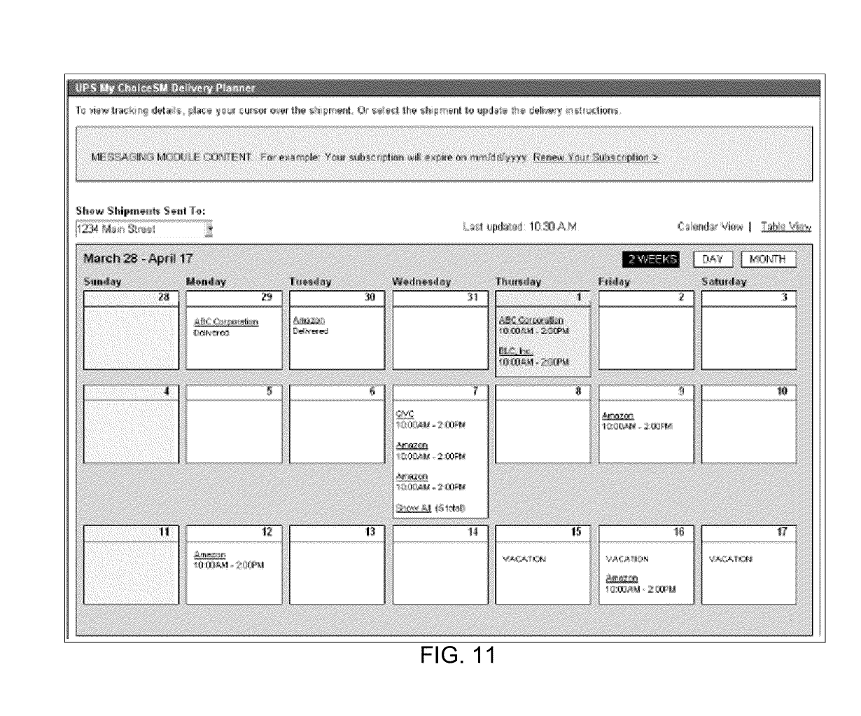

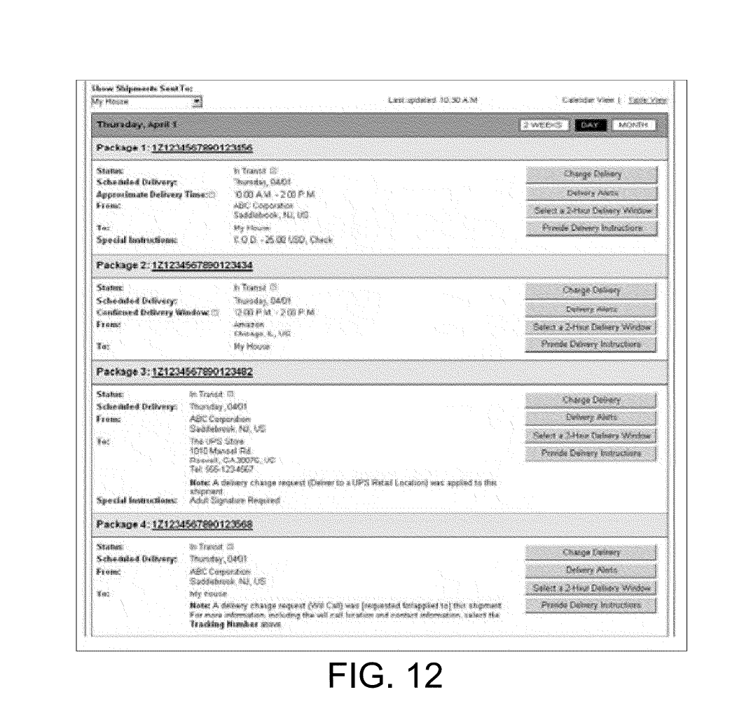

In one embodiment, by appending the shipping information/data with the appropriate customer identifier, the corresponding customer, retailer and/or third party can view tracking information/data for any shipments associated with the customer profile. For instance, as shown in FIGS. 10-12, the carrier system 100 and/or retailer system/third party system 125 can be used to identify (e.g., retrieve the shipping information/data with the appropriate customer identifier) all shipments associated with a customer (e.g., customer profile) using the customer identifier and provide them to the customer for viewing in a customer-friendly format, such as via an interface (e.g., browser, dashboard, webpage, application). FIG. 10 shows an exemplary interface (e.g., browser, dashboard, webpage, application) with a list of all inbound shipments to a customer. FIG. 11 shows an interface with a calendar (which may have a day view, a week view, a multiple week view, and/or a month view) having a list of all inbound shipments to a customer. The calendar may also show item events as the item progresses through the carrier's transportation and logistics network (e.g., the date and location of a pick-up, the date and location of intermediate location events, and/or the date and location of the delivery event). The calendar may also comprise various other retailer events (e.g., expected in-stock data, expected ship date, ship date, and/or the like). In FIG. 11, the calendar can be sorted by physical delivery address, indicating that the customer has more than one physical delivery address associated with the customer profile. FIG. 12 shows an interface (e.g., browser, dashboard, webpage, application) with a list of all inbound shipments to a customer. As will be recognized, a variety of other approaches and techniques can be used to adapt to various needs and circumstances, such as only displaying the deliveries for a defined time frame/period (e.g., the past 90 days)

In various embodiments, these concepts can provide customers with ongoing visibility of all inbound packages (e.g., FIGS. 10, 11, and 12), as well as preferences, regardless of carrier. For instance, for each item, the interface (e.g., browser, dashboard, webpage, application) can be used to show the item/shipment identifier, a delivery indicator, a last activity scan date, a non-confirmed delivery window, a confirmed delivery window a commit time, whether an in-person signature is requested for delivery, a delivery service level, and/or various other information. Thus, through such an interface, customers (e.g., operating customer computing entities 110/120) can review and access all inbound shipments (from one or more carriers) using a single interface. As will be recognized, though, a variety of other approaches and techniques can be used to provide tracking information/data to a customer.

### 4. Messages/Alerts

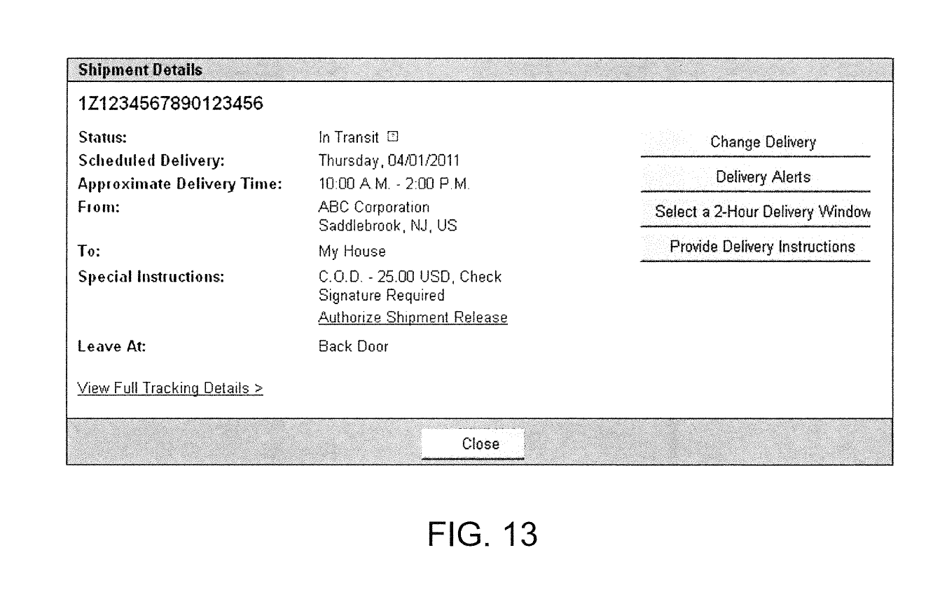

In one embodiment, customers (e.g., operating customer computing entities) can customize and/or provide communication preferences regarding items to be picked up from or delivered to the customers (shown in FIG. 13). For example, the communication preferences may provide customers with the ability to request messages for items before the carrier attempts to pick up or deliver items (e.g., prior to the first delivery attempt by the carrier) and/or after items have been picked up or delivered.

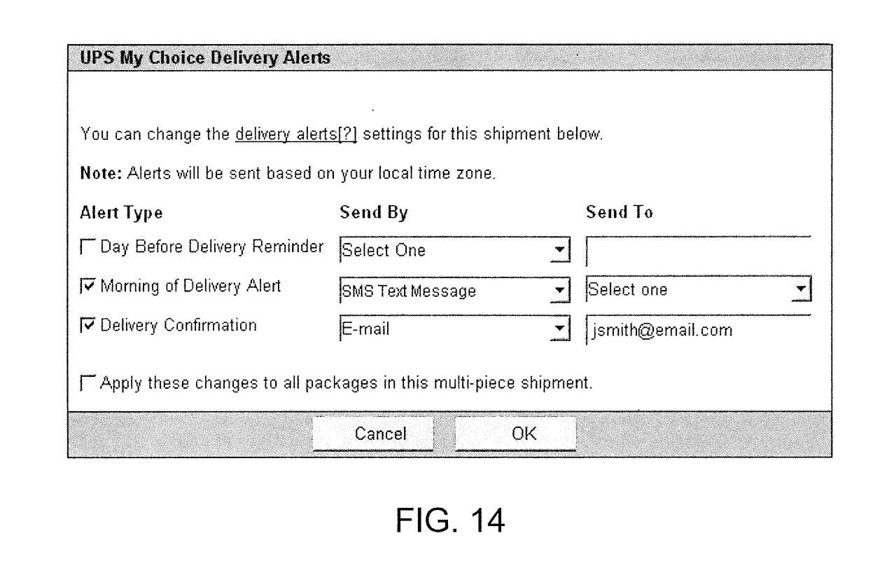

In one embodiment, as shown in FIG. 14, a customer (e.g., operating a consignee computing entity 110 or consignor computing entity 120) can identify one or more communication formats for communicating with the customer. The communication formats may include text messages (e.g., Short Message Service (SMS) and/or Multimedia Messaging Service (MMS), email messages, voice messages, video message (e.g., YouTube, the Vine), picture message (e.g., Instagram), social media message (e.g., private social media created internally for entities, business social media (e.g., Yammer, SocialCast), or public social media (e.g., Facebook, Instagram, Twitter)), and/or a variety of other messages in various communication formats. In addition to identifying one or more communication formats, the customer (e.g., operating a customer computing entity 110/120) can identify the corresponding electronic destination addresses to be used in providing information/data regarding items to be picked up from or delivered to the customer. For instance, for text messages, the customer may provide one or more cellular phone numbers. For email messages, the customer may provide one or more email addresses. And for voice messages, the customer may provide one or more cellular or landline phone numbers. Additionally, in one embodiment, validation operations can be performed with respect to each input electronic destination address—to ensure their accuracy. As will be recognized, a variety of other types of electronic destination addresses can be used to adapt to various needs and circumstances.

In one embodiment, customers (e.g., operating a consignee computing entity 110 or consignor computing entity 120) may indicate the type of messages they want to receive (e.g., the content). For example, a customer may indicate that he only wants to receive messages when the shipping information/data for an item indicates that an in-person signature from the customer is requested for delivery of the item, when the pick-up or delivery options for the item can be changed, when instructions for pick-up or delivery of the item can be provided, or when the pick-up or delivery service level of the item can be changed. In another example, a customer may indicate that he wants to receive messages for all items to be picked up from or delivered to the customer with expected dates and times. In yet another embodiment, a customer may indicate the he wants to receive messages for items that are automatically re-routed or when a fee will be assessed for delivering an item in accordance with the customer's automatic service schedule. As will be recognized, customers may indicate that they want to receive messages regarding items in a variety of other circumstances as well.

In one embodiment, customers (e.g., operating a consignee computing entity 110 or consignor computing entity 120) may identify/define time frames/periods in which the messages providing information/data regarding items to be delivered should be transmitted to the customer. For instance, the time frames/periods may include (a) after shipment and the day before an item is delivered and (b) after shipment and the morning of the day of delivery. In such cases, the messages can serve as a reminder to the customer that an item is being delivered (e.g., 48 hours before, 24 hours before, 8 hours before, 4 hours before, 2 hours before, 1 hour before, 30 minutes before, 15 minutes before, when the driver enters a geofence or other designated area, and/or the like). Similarly, the time frames/periods may be after delivery for confirmation of delivery or even after an unsuccessful delivery attempt to the customer. In such a case, the customer may define where and how messages regarding such unsuccessful delivery attempts should be made as part of the communication preferences or allow the carrier system 100 and/or retailer system/third party system 125 to track the customer for delivery after an unsuccessful attempt. As will be recognized, the carrier system 100 and/or retailer system/third party system 125 can store communication preferences for providing information/data in association with the customer profiles. Moreover, the communication preferences may apply to the customer profile globally, to selected customer addresses, to groups of items, and/or an item-by-item basis.

In one embodiment, the carrier system 100 and/or retailer system/third party system 125 may impose time constraints for placing, generating, and/or transmitting messages within the time frames/periods identified by the customers. For example, the carrier system 100 and/or retailer system/third party system 125 may only transmit text messages to customers between 6:00 am-11:00 pm (based on time zones). Similarly, the carrier system 100 and/or retailer system/third party system 125 may place calls and transmit automated voice messages between 8:00 am-9:00 pm (based on time zones). And for email messages, the carrier system 100 and/or retailer system/third party system 125 may generate and transmit them without time constraints.

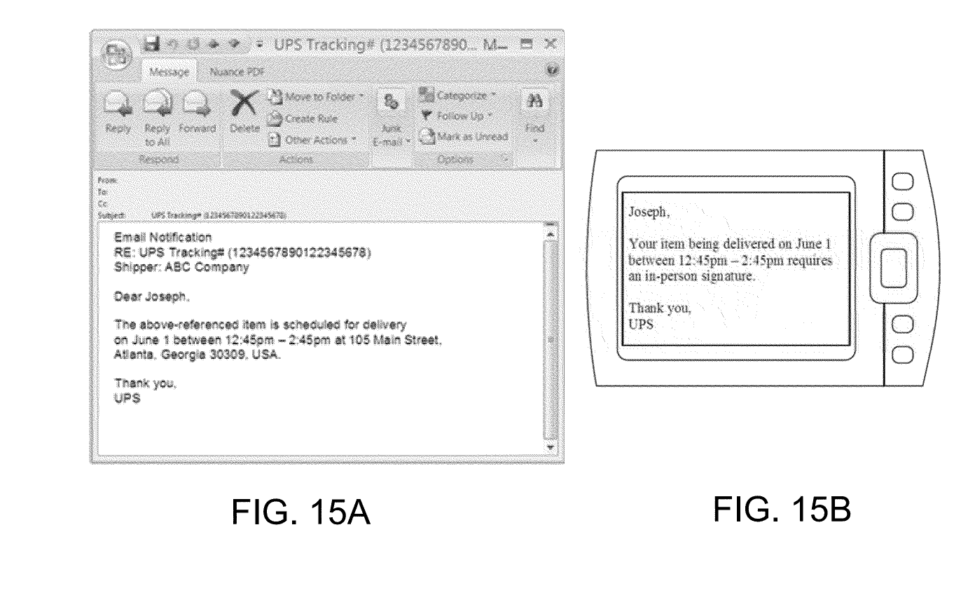

In one embodiment, the carrier system 100 and/or retailer system/third party system 125 can automatically generate (e.g., via the message module) one or more messages providing information/data regarding an item to be delivered to the customer (Block 425 of FIG. 4) in compliance with the customer's communication preferences and the carrier's time constraints. Similarly, the carrier system 100 and/or retailer system/third party system 125 can automatically transmit the one or messages to the electronic destination addresses in compliance with the customer's communication preferences and the carrier's time constraints. For example, the carrier system 100 and/or retailer system/third party system 125 may generate and transmit an email message to Joseph Brown's email address and a text message to Joseph's cellular phone the day before an item is to be delivered to Joseph's home address. The messages may indicate the expected delivery date and/or delivery time, such as shown in FIGS. 15A and 15B, and a variety of other information. As will be recognized, a variety of other operations and processes may be used with embodiments of the present invention. These operations and processes can be customized to adapt to various needs and circumstances.

### 5. Pick-Up/Delivery Times

In one embodiment, an interface (e.g., browser, dashboard, application from a carrier and/or retailer) provided by the carrier system 100 and/or the retailer system/third party system 125 can be used to view expected, estimated, confirmed, and/or guaranteed pick-up and/or delivery times or determine/identify expected, estimated, confirmed, and/or guaranteed pick-up and/or delivery times. As described herein, the terms pick-up and delivery times and times windows encompass particular days and/or dates as well. For instance, a delivery time may also include a delivery date. In one embodiment, expected, estimated, confirmed, and/or guaranteed time windows may indicate an expected, estimated, confirmed, and/or guaranteed pick-up or delivery time of an item based on historical pick-up or delivery times to the area (e.g., historical information/data). Such pick-up and/or delivery information/data may be sent by the carrier system 100 to a retailer system/third party system 125 to display to customers (e.g., operating appropriate customer computing entities 110/120) as part of their online shopping experience. For example, in one embodiment, various triggers may cause a retailer system/third party system 125 to send customer information/data and/or shipping information/data to the carrier system 100 to obtain expected, estimated, confirmed, and/or guaranteed pick-up or delivery times for one or more items to be delivered to the customer from the retailer. For instance, when a customer (e.g., operating an appropriate customer computing entity 110/120) accesses a retailer system (e.g., shopping via browser, dashboard, application from a retailer), the retailer system/third party system 125 can identify the customer and send customer information/data and/or shipping information/data to the carrier system 100. The retailer system/third party system 125 can identify the customer from cookies stored on the customer computing entity 110/120, by the customer (e.g., operating an appropriate customer computing entity 110/120) logging into the customer's account with the retailer, by requesting geographic information/data, and/or the like. With the customer identified, the retailer system/third party system 125 can provide customer information/data and/or shipping information/data to the carrier system 100. As previously described, with the customer information/data and/or shipping information/data, the carrier system 100 and/or the retailer system/third party system 125 can identify a customer profile corresponding to the information/data (e.g., based on addresses, names, email addresses, home, business, car, and/or mobile phone numbers, and/or the like).

In one embodiment, while the customer is, for example, shopping at or otherwise browsing items on a retailer website, after identifying the appropriate customer profile based on the customer information/data and/or shipping information/data, the carrier system 100 and/or the retailer system/third party system 125 can determine/identify expected, estimated, confirmed, and/or guaranteed pick-up or delivery times (including pick-up or delivery windows) before, during, or subsequent to selection of item, placement of an item in a shopping cart, a checkout process, shipping of the item and/or the like. These determinations can be made for each of one or more items that may be or are to be transported by the carrier and/or for items that are being purchased or may be purchased from the retailer. For example, while browsing, a user may place or search that results in or navigate to a page resulting in display of one or more items. Having identified the appropriate customer profile, the carrier system 100 and/or the retailer system/third party system 125 can determine/identify expected, estimated, confirmed, and/or guaranteed pick-up or delivery times (including pick-up or delivery windows) for each of one or more of the displayed items. In other embodiments, before browsing a retailer website, such as for example, upon navigation to and display of the retailer website, the carrier system 100 and/or the retailer system/third party system 125 can determine/identify expected, estimated, confirmed, and/or guaranteed pick-up or delivery times (including pick-up or delivery windows) that may be available for selection. In one embodiment, the carrier system 100 and/or the retailer system/third party system 125 can make these determinations, for example, based on historical information/data. For instance, the historical information/data may include delivery times and/or windows from the past 24 months, 12 months, 6 months, 90 days, and/or any other time frame/period. Based on the historical information/data, the carrier system 100 and/or the retailer system/third party system 125 can determine/identify one or more expected, estimated, confirmed, and/or guaranteed pick-up or delivery times (including pick-up or delivery windows). For instance, if the historical information/data indicates that items are generally able to be delivered to 123 Main Street by around 2:00 pm, the carrier system 100 and/or the retailer system/third party system 125 may determine/identify one or more delivery times (e.g., 2:00 pm or later and/or one or more delivery windows such as 1:00 pm-3:00 pm, 2:00 pm-4:00 pm, etc. Further, the carrier system 100 and/or the retailer system/third party system 125 can also make such determinations in light of expected or forecasted item volumes to adjust the same. For instance, the carrier system 100 and/or the retailer system/third party system 125 can adjust the times or time windows to be later if expected volumes are high or to be earlier if expected volumes are low. The carrier system 100 and/or the retailer system/third party system 125 can also make such determinations in light of customer-defined service schedules and/or a variety of factors, conditions, requirements, parameters, and/or similar words (e.g., seasons, holidays, weather conditions, travel conditions, environmental conditions, safety conditions, and/or the like. Such automatic service schedules are also described in U.S. application Ser. No. 14/025,893, which is hereby incorporated in its entirety by reference.

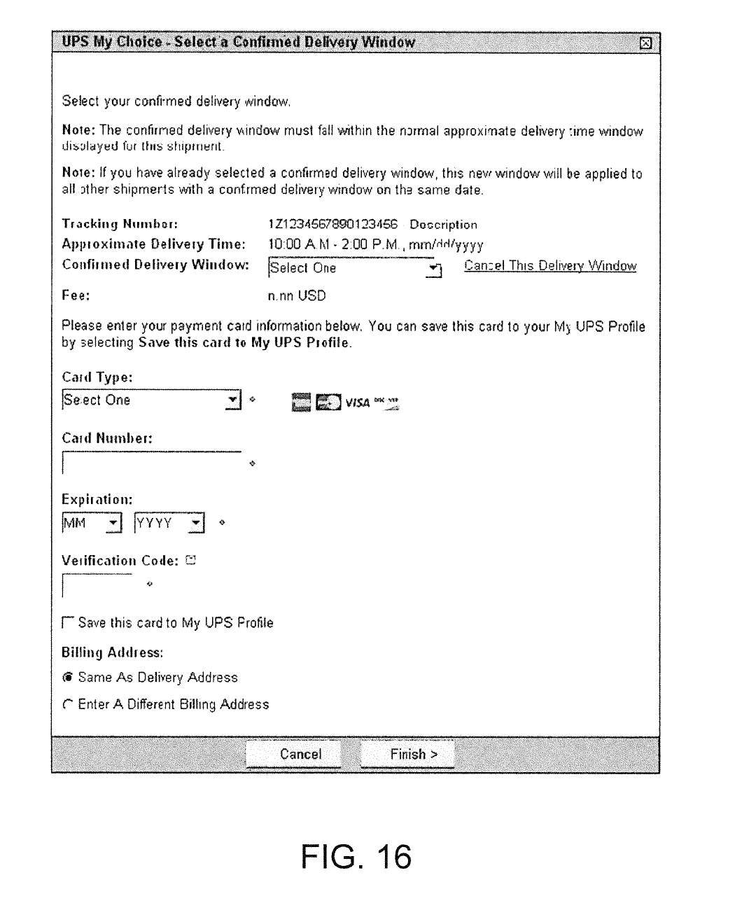

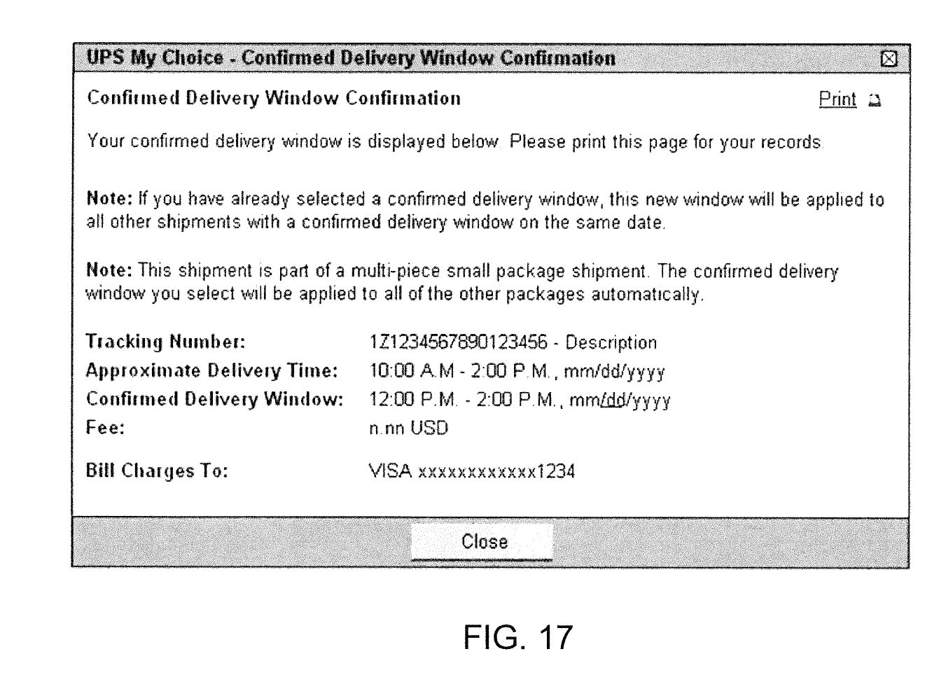

In another embodiment, the carrier system 100 and/or the retailer system/third party system 125 can determine/identify or identify multiple expected, estimated, confirmed, and/or guaranteed pick-up or delivery times (including pick-up or delivery windows). In an online environment, this may allow for customers to select a specific delivery time or delivery time window before an item is purchased, as part of the checkout process, after an item has been received by the carrier for transport, and/or the like. As will be recognized, the carrier system 100 and/or the retailer system/third party system 125 may also provide costs associated with each delivery time or time window. For example, if the carrier system 100 and/or the retailer system/third party system 125 determines that the expected, estimated, confirmed, and/or guaranteed delivery time is 2:00 pm and/or that the applicable delivery window is 1:00 pm-3:00 pm, the carrier system 100 and/or the retailer system/third party system 125 can provide this service at no additional charge or for any amount desired or determined. However, the carrier system 100 and/or the retailer system/third party system 125 can also provide other delivery times and time windows, such as 11:00 am (or 10:00 am-12:00 pm) and 6:00 pm (or 5:00 pm-7:00 pm), with a cost/charge corresponding to each time or time window. For the delivery times or time windows, the carrier system 100 and/or the retailer system/third party system 125 may determine/identify that the costs for delivery at these delivery times or within these delivery time windows will cost an additional $12.00. In one embodiment, as the specificity of the time or the time window increases, the cost may increase. This approach can be used to provide customers with greater flexibility over their pick-up and delivery services, as shown in FIGS. 16 and 17. Table 2 below provides illustrative estimated pick-up or delivery windows and confirmed pick-up or delivery windows from which the customer can select to have an item picked up or delivered. As will be recognized, a variety of approaches and techniques can be used to adapt to various needs and circumstances.

TABLE 2

| Estimated Windows | Confirmed Windows |
|---|---|
| 11:45am-3:45pm | 11:45am-1:45pm |
| | 12:45pm-2:45pm |
| | 1:45pm-3:45pm |
| 11:30am-3:30pm | 11:30am-1:30pm |
| | 12:30pm-2:30pm |
| | 1:30pm-3:30pm |
| 2:00pm-5:45pm | 2:00pm-4:00pm |
| | 3:45PM-5:45pm |
| 1:00pm-4:15pm | 1:00pm-3:00pm |
| | 2:15pm-4:15pm |
| 8:00am-11:00pm | 8:00am-10:00am |
| | 9:00am-11:00am |
| 3:00pm-6:00pm | 3:00pm-5:00pm |
| | 4:00pm-6:00pm |
| 3:00pm-5:45pm | 3:00pm-5:00pm |
| | 3:45pm-5:45pm |
| 4:00pm-6:00pm | 4:00pm-6:00pm |

In some embodiments, the carrier system 100 and/or the retailer system/third party system 125 can present one or more expected, estimated, confirmed, and/or guaranteed pick-up and/or delivery dates, times, time windows and/or associated costs (pick-up and/or delivery information/data) for view and/or selection by customers (e.g., operating customer computing entities 110/120). For example, as shown in 6. Enhanced Delivery Time/Window and Cost Concepts, a customer (e.g., operating a customer computing entity 110/120) can select from a plurality of delivery times/windows and the corresponding costs (if applicable) as part of an online shopping experience (e.g., before, during, or subsequent to selection of item, placement of an item in a shopping cart, a checkout process, shipping of the item and/or the like). Latency may be reduced by providing customer information/data and/or shipping information/data to the carrier as early as possible (e.g., when the customer accesses the retailer's website, add an item to a cart, checkouts, and/or the like). Responsive to a selection of a delivery time and/or delivery time window, the carrier system 100 and/or the retailer system/third party system 125 can update the shipping information/data (e.g. pick-up, sort, delivery date and times) correspondingly for delivery at during a selected window or, in some embodiments, during the specified time within the specified window. Such selections may also determine/identify what delivery service level should be used. Further, although much of the preceding is discussed in the context of deliveries, the same is applicable to pick-ups.

Additional information/data regarding such time windows can be found in U.S. Pat. No. 6,701,299, U.S. Pat. No. 7,233,907, and U.S. Pat. No. 7,925,524, all of which are incorporated herein in their entireties by reference. As will be recognized, a variety of other operations and processes may be used with embodiments of the present invention. These operations and processes can be customized to adapt to various needs and circumstances.

### 6. Enhanced Delivery Time/Window and Cost Concepts

In some embodiments, an interface (e.g., browser, dashboard, application from a carrier and/or retailer) in communication with the carrier system 100 and/or retailer system/third party system 125 can be used to automatically provide and receive selection of, for example, one or more expected, estimated, confirmed, and/or guaranteed pick-up and/or delivery dates, times, time windows and/or associated costs (pick-up and/or delivery information/data). In one embodiment, pick-up and/or delivery dates, times, time windows and/or associated costs may be determined/identified based on historical information/data and/or dynamic information/data. The pick-up and/or delivery information/data may be sent by the carrier system 100 to a retailer system/third party system 125 to display to customers (e.g., operating appropriate customer computing entities 110/120) as part of the online shopping experience.

For example, a customer (e.g., a customer or customer representative operating a consignee computing entity 110 or consignor computing entity 120) may access the interface (e.g., browser, dashboard, application) in communication with the carrier system 100 and/or retailer system/third party system 125, while for example, shopping online via the retailer's website, application, and/or the like, to view an item and one or more expected, estimated, confirmed, and/or guaranteed pick-up or delivery times for the item, before, during, and/or after purchase. The retailer system/third party system 125 can identify the customer and send customer information/data and/or shipping information/data to the carrier system 100. The carrier system 100 and/or the retailer system/third party system 125 can identify the customer from cookies stored on the customer computing entity 110/120, by the customer (e.g., operating an appropriate customer computing entity 110/120) logging into the customer's account with the retailer, by requesting geographic information/data, and/or the like. With the customer identified, the retailer system 125 can provide customer information/data and/or shipping information/data to the carrier system 100. As previously described, with the customer information/data and/or shipping information/data, the carrier system 100 and/or the retailer system 125 can identify a customer profile corresponding to the information/data (e.g., based on addresses, names, email addresses, phone numbers, zip codes, area codes, neighborhoods, and/or the like).

Furthermore, in some embodiments, the interface (e.g., browser, dashboard, application from a carrier and/or retailer) in communication with the carrier system 100 and/or retailer system/third party system 125 can be used to automatically provide time-in-transit information/data (also referred to herein as pick-up and/or delivery information/data) to the retailer system/third party system 125 for one or more fulfillment centers, drop-ship locations, and/or the like. As will be understood by those skilled in the art, many online retailers have multiple fulfillment centers or drop-ship locations distributed throughout a geographic area from which an order may be fulfilled. In some embodiments, each of the multiple fulfillment centers and/or drop-ship locations are staffed (e.g., a “brick and mortar” store and/or the like) or unstaffed (e.g., a “drop box” and/or the like). A carrier system 100 may provide time-in-transit information/data (e.g., pick-up and/or delivery information/data) from each fulfillment center or drop-ship location to different geographic areas (e.g., zip codes, cities, states, regions, and/or the like). Of course, if the online retailer has a single fulfillment center or drop-ship location, time-in-transit information/data (e.g., pick-up and/or delivery information/data) would be provided for that single location. This time-in-transit information/data (e.g., pick-up and/or delivery information/data) may be used by the online retailer to determine a tender date as will be discussed in greater detail below. However, in certain embodiments, the carrier may not provide time-in-transit information/data (e.g., pick-up and/or delivery information/data). For example, the carrier may provide a tendered date as opposed to a delivery date and thus the time-in-transit would be included in the calculation of the tendered date as will be described in greater detail below. In some embodiments, time-in-transit information/data (e.g., pick-up and/or delivery information/data) may be provided and/or viewed before, during, and/or after a purchase. In some embodiments, item location and/or other item characteristics (e.g., size, special handling instructions and/or the like) may factor into the time-in-transit information/data (e.g., pick-up and/or delivery information/data).

In some embodiments, after identifying the appropriate customer profile based on the customer information/data and/or shipping information/data, the carrier system 100 and/or the retailer system/third party system 125 may determine/identify expected, estimated, confirmed, and/or guaranteed pick-up or delivery times (including pick-up or delivery windows) and/or associated costs. In some embodiments, the carrier system 100 and/or the retailer system/third party system 125 can determine/identify expected, estimated, confirmed, and/or guaranteed pick-up or delivery dates and/or times (including pick-up or delivery windows) for unregistered and/or unauthenticated customers and/or without identifying a corresponding customer profile. Such determinations may be made for an item before, during, and/or after purchase (e.g., items that are to be or is being transported by the carrier and/or that are being purchased or may be purchased from the retailer). In one embodiment, the carrier system 100 and/or the retailer system/third party system 125 can make these determinations, for example, based on historical information/data and/or dynamic information/data. Whereas, in other embodiments, the carrier system 100 and/or the retailer system/third party system 125 are configured to make these determinations, for example, based upon other parameters. Additional information/data regarding determination of customer-selectable time windows can be found in U.S. patent application Ser. No. 14/664,202, filed on Mar. 20, 2015, which is incorporated by reference herein.

a. System Operation

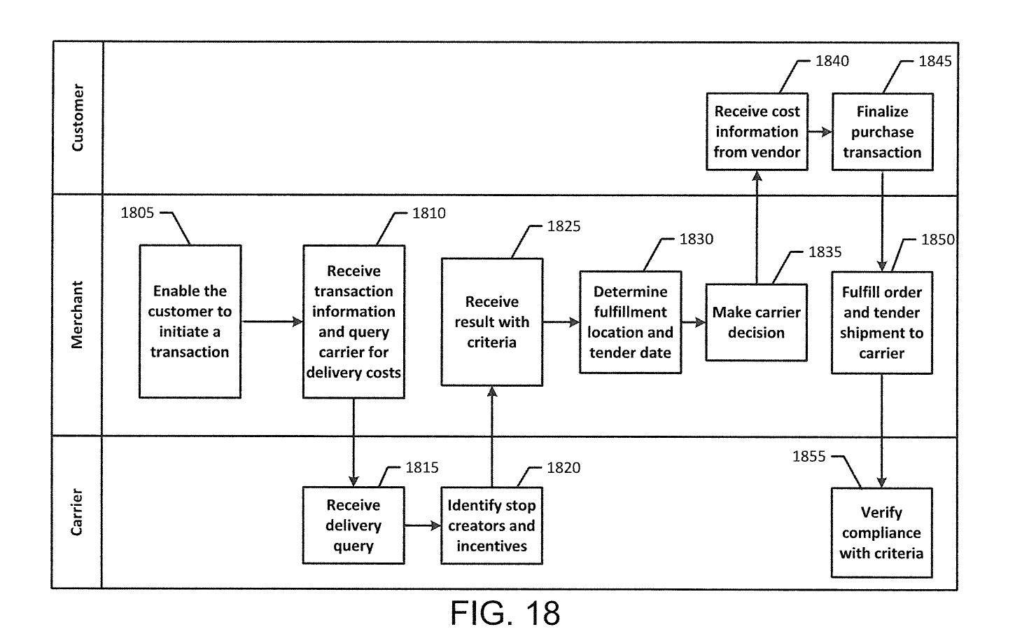

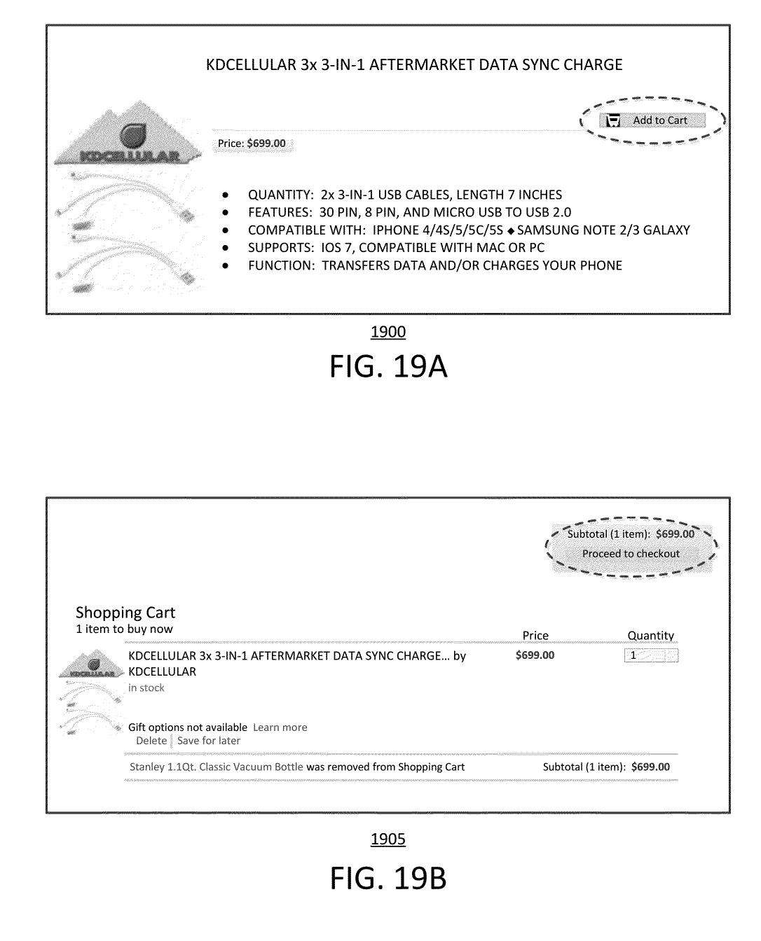

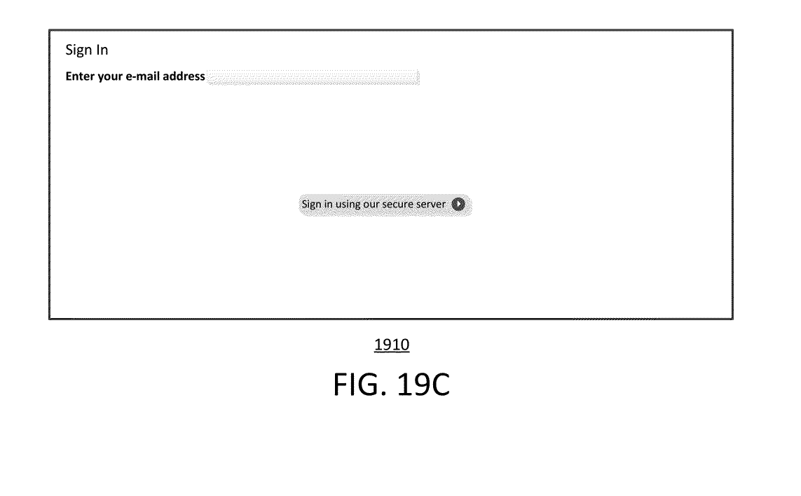

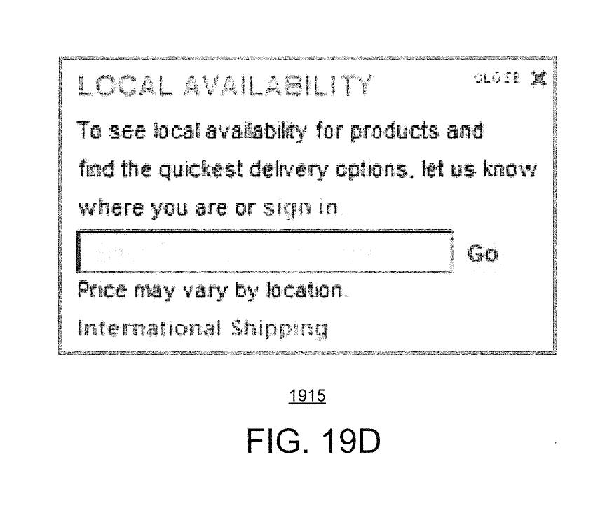

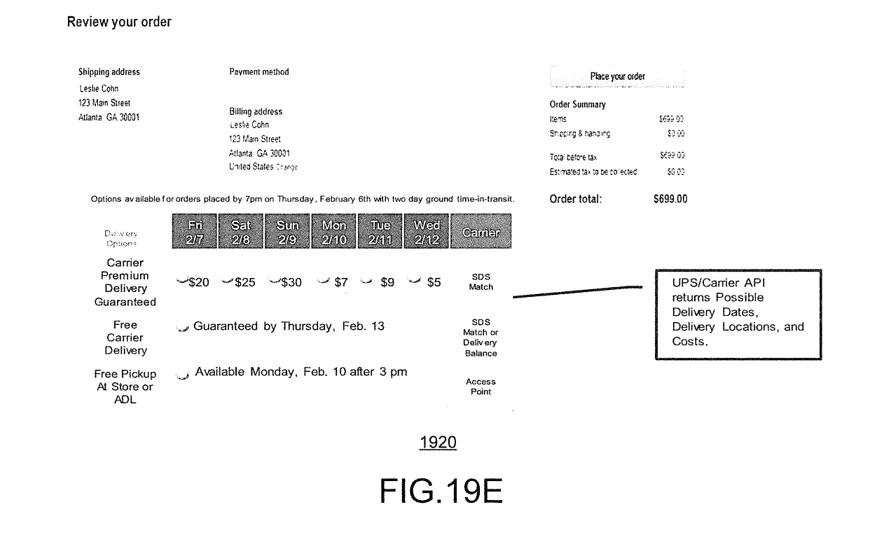

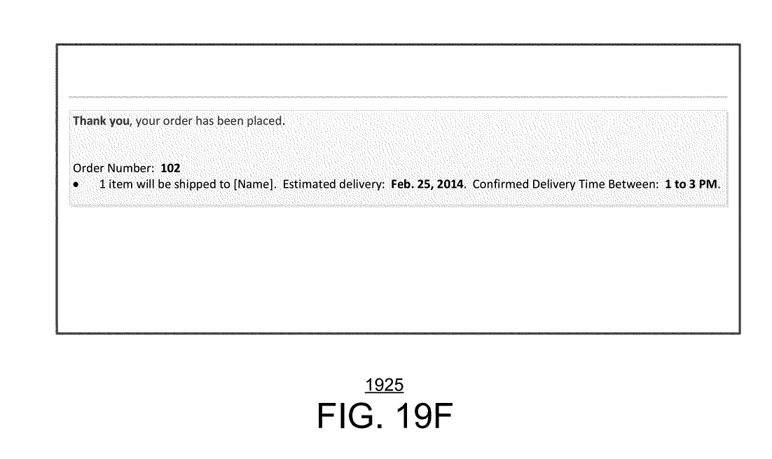

FIG. 18 shows a flowchart illustrating a process that may be performed by a retailer system/third party system 125 and/or a carrier system 100 for providing to and/or receiving selection of, for example, one or more expected, estimated, confirmed, and/or guaranteed pick-up and/or delivery dates, times, time windows and/or associated costs (pick-up and/or delivery information/data) to, for example, authenticated users as well as non-authenticated users, including but not limited to online shoppers utilizing one of the retailer's website (e.g., www.retailer.com), a retailer login API, and/or a carrier API (e.g., Carrier Accelerated Program Enrollment API). The flowchart shown in FIG. 18 will be described with reference to example displays 1900-1950 shown in FIGS. 19A-19E. FIGS. 19A-19E show example displays 1900-1950 that may be presented by one or more display screens of one or more devices, such as those used by a user, such as a customer, consignee, consignor, retailer, and/or the like, which as described above, may be referred to herein as a consignee computing device 110 or consignor computing entity 120. While the example displays 19A-19E are configured to be shown on a computer monitor, laptop screen, tablet computer, or other device having similar dimensions, similar interfaces may be utilized with other types of devices (e.g., mobile telephone, “smart phone,” etc.) discussed herein and modified accordingly (e.g., for screen size, input device compatibly, ease of use, etc.). Note that the portion of the displays described herein may be labeled differently and not necessarily as shown.

Returning to FIG. 18, in some embodiments, an authenticated or non-authenticated customer (e.g., operating a customer computing entity 110/120) may access the retailer system (e.g., shopping online via the retailer) and browse one or more items for purchase. That is, in some embodiments, the retailer system/third party system 125, as is shown in operation 1805, may include means, such as processor 205 and/or the like, for, enabling a customer (e.g., operating a customer computing entity 110/120) to initiate a purchase transaction by indicating a desire to purchase an item. As part of the purchase transaction, the retailer system/third party system 125 may request the customer to provide an email address, a delivery address and/or other customer information/data for the items and may, in some embodiments, provide to and/or allow the customer to select a delivery service level option such as next day, 2-3 business days, 5-7 business days, and/or the like. In other embodiments, the retailer system/third party system 125 may provide multiple delivery dates for selection by the customer.

For example, displays 1900-1915 of FIGS. 19A-19E, respectively, show a process for using a retailer website to make a purchase of a product. As is shown, FIG. 19A shows a display 1900 screen that may be displayed by a device with which an item may be viewed and purchased, by for example, selecting “Add to Cart.” FIG. 19B shows a display 1905 that may be displayed after selection of “Add to Cart,” particularly showing the “cart,” the “cart” comprising the selected item, a corresponding quantity and price as well as, in some embodiments, any other previously selected items and/or information/data indicative of items that may have been removed, prices changes, and/or the like. Furthermore, display 1905 may configured such that items in the cart may be purchased by selecting “Proceed to Checkout.” As will be recognized, a variety of approaches and techniques can be used to adapt to various needs and circumstances.

A retailer system/third party system 125 (e.g., in communication with customer computing entities 110/120 and/or carrier systems 100), as is shown in operation 1810, may include means, such as processor 205 and/or the like, for, communicating some or all of the customer information/data and/or shipping information/data including the delivery address and the promised delivery date information/data to the carrier system 100. The promised delivery date information/data may include an actual date or a range of delivery dates (e.g., covering the next four, five, six, or seven days). In some embodiments, only the customer information/data or shipping information/data is provided. The shipping information/data may be provided as a postal address, a zip code, a landmark identification, a retail store, a restaurant, a latitude and longitude location, a GPS enabled mobile device, or any other technique for identifying a location. The shipping information/data may be communicated by the one or more retailer systems 125 to the carrier system 100 and/or the retailer system/third party system 125 using an Application Programming Interface (API), user interface, integrated software, pop-up windows or other communication protocols or paths.

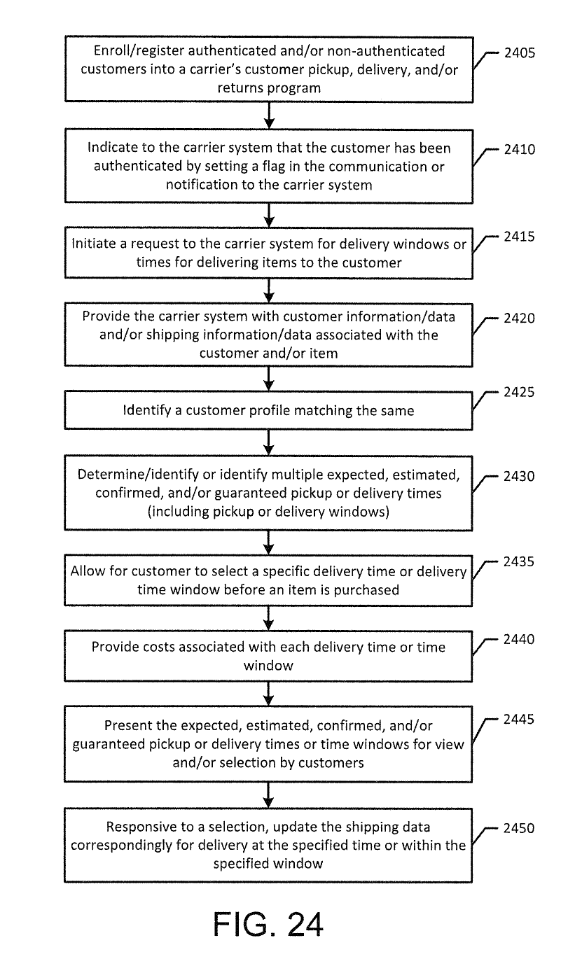

In some embodiments, the carrier system 100 and/or the retailer system/third party system 125 may include means for determining the location of the customer. That is, location may be determined for both authenticated customers and non-authenticated customers, because, in some embodiments, benefits, such as one or more delivery windows available for selection, may be provided regardless of authentication. For example, location may be determined via customer entered data, customer profile data, and/or using the IP address or GPS functionality of the customer computing entity 110/120. For example, FIG. 19C shows a display 1910 that may be displayed by the retailer system/third party system 125 requesting an email address enabling the customer to sign into the retailer's secure server, the secure server storing customer profile information/data and/or the like, enabling the retailer system/third party system 125 to determine the location of the customer. Additionally or alternatively, in some embodiments, location may be requested. FIG. 19D shows a display 1920 that may be presented by the retailer system/third party system 125 to a customer (e.g., operating a customer computing entity 110/120) displaying a pop-up window requesting customer location information/data (e.g., a zip code). In some embodiments, the retailer system may determine the customer's location before, during, or subsequent to selection of item, placement of an item in a shopping cart, a checkout process, shipping of the item and/or the like in order provide potential and/or available delivery windows to the customer. Whereas, in other embodiments, location may be determined later. Moreover, in some embodiments, retailer system/third party system 125 may include means, such as processor 205 and/or the like, for determining the authentication of a customer, which is discussed below with reference to FIG. 24, for providing one or more additional benefits to those consumers that are determined to be authenticated and, in some embodiments, those consumers who elect to receive/select delivery windows, or in some embodiments, cost and/or pick-up or drop-ship locations, and are temporarily enrolled in the authentication process.

Returning to FIG. 18, in some embodiments, a carrier system 100, as is shown in operation 1815, may include means, such as processor 205 and/or the like, for, receiving the customer information/data and/or shipping information/data from the retailer system/third party system 125. Using the customer information/data and/or shipping information/data, the carrier system 100 and/or retailer system/third party system 125 (e.g., in communication with customer computing entities 110/120 and/or carrier systems 100), as is shown in operation 1820, may include means, such as processor 205 and/or the like, for determining whether synchronized delivery with a stop creator shipment is possible (or probable), for example, to increase and/or decrease density to provide a delivery cost and/or the amount of the cost to the retailer system/third party system 125.

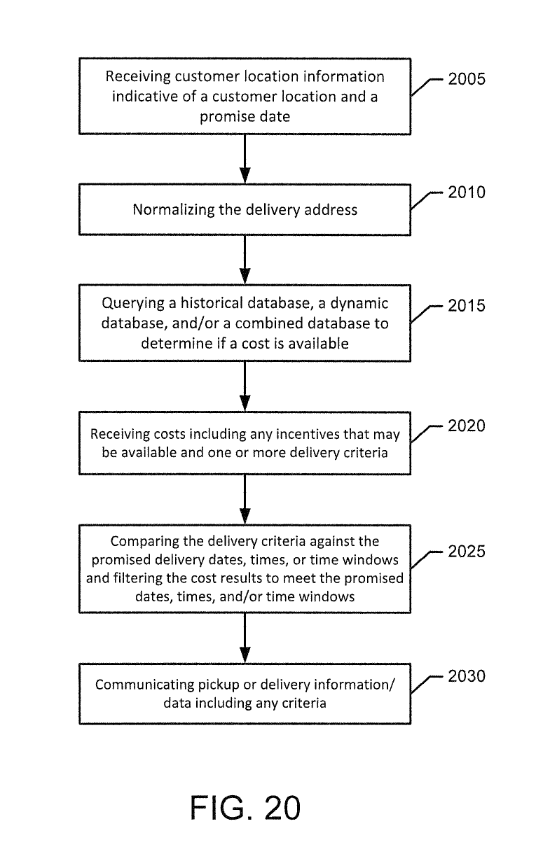

FIG. 20, which will discussed in detail below, provides a flowchart illustrating the steps that may be performed by the carrier system 100, the retailer system/third party system 125, and/or various other systems and entities to determine (a) whether synchronized delivery with a stop creator shipment is possible (or probable), for example, to increase or decrease density (and/or influence delivery parameter selections) and/or (b) whether a delivery cost is appropriate according to various embodiments.

Returning to FIG. 18, the retailer system/third party system 125 (e.g., in communication with customer computing entities 110/120 and/or carrier systems 100), as is shown in operation 1825, may include means, such as processor 205 and/or the like, for receiving the pick-up and/or delivery information/data from the carrier system 100. In the event the pick-up and/or delivery information/data provides one or more delivery dates and/or times, the retailer system/third party system 125 may include means, such as processor 205 and/or the like, for using the time-in-transit information/data (e.g., pick-up, transportation, sortation, and/or delivery information/data) communicated earlier by the carrier to calculate a tender date for the shipment for desired fulfillment centers or drop-ship locations, as in shown at block 1830. For example, the carrier system 100 and/or the retailer system/third party system 125 may communicate that a February 1 delivery date is available for the determined/identified cost. In conjunction with the time-in-transit information/data (e.g., pick-up and/or delivery information/data) previously provided, the one or more retailer systems 125 may use the February 1 designation to (a) select a particular fulfillment center or drop-ship location and (b) determine the tender date to the carrier. The fulfillment center may be selected based at least in part on the required delivery service level necessary to meet the February 1 delivery date and the availability of the purchased items at the fulfillment center. Working backwards from the provided delivery date, the retailer system/third party system 125 may subtract the previously provided time-in-transit to arrive at the necessary tender date. At this point the retailer system/third party system 125 may calculate a shipping cost including the cost associated with the shipping the item from the fulfillment center pursuant to the necessary service level and associated cost.

The retailer system/third party system 125 (e.g., in communication with customer computing entities 110/120 and/or carrier systems 100), as is shown in operation 1835, may include means, such as processor 205 and/or the like, for using the calculated cost to determine which of multiple different carriers to use for a particular shipment. After making this determination, as is shown in 1840, the retailer system/third party system 125 may communicate the shipping cost, among other data, to the customer (e.g., operating customer computing entities 110/120) in anticipation of an order confirmation. The customer (e.g., operating customer computing entities 110/120) may then consider the information/data and finalize the purchase transaction, as is shown at Block 1845.

Once the order is received by the retailer system/third party system 125, the retailer/third party may fulfill the order and tender the shipment to the carrier. That is, the retailer system/third party system 125, as is shown in operation 1850, may include means, such as processor 205 and/or the like, for performing order fulfillment and providing/accessing information/data to the carrier system 100. In various embodiments, the retailer system/third party system 125 may repeat the cost query after receiving the order to verify the cost. In some cases, new stop creator items may be received between the initial determination and the receipt of the order that may result in a possible synchronization to increase and/or decrease density and/or influence delivery parameter selections. In addition, new stop creator items may be received between the initial determination and the determined tender date. In various embodiments, the one or more carrier systems 100 may periodically (e.g., hourly, daily, and/or the like) analyze the dynamic information/data to determine if new stop creator items are received.

In various embodiments, the carrier system 100 and/or the retailer system/third party system 125 may provide a token or unique identifier with the cost to the retailer system/third party system 125 for use in identifying the shipment. In use, the retailer system/third party system 125 may include the unique identifier on the label, provide with the package level detail (PLD) information/data communicated to the carrier or otherwise associate the unique identifier with the shipment. When the shipment is tendered to the carrier, the carrier system 100 and/or retailer system/third party system 125 (e.g., in communication with customer computing entities 110/120 and/or carrier systems 100), as is shown in operation 1855, may include means, such as processor 205 and/or the like, for capturing the unique identifier and verifying whether the shipment criteria has been met to receive the determined/identified cost.

In various embodiments, the customer (e.g., the consignee) may take steps to increase the possibility that a synchronized delivery can be achieved to increase or decrease density. For example, the customer may select a specific date, time, time window, and/or to receive items to reduce shipping costs. For example, as shown in FIG. 19E, the carrier system 100 and/or the retailer system/third party system 125 may present, for example, display 1920, showing the expected, estimated, confirmed, and/or guaranteed pick-up or delivery dates, times, time windows, and/or associated costs for view and/or selection by customers following the processes and operations previously described. Moreover, a customer (e.g., operating a customer computing entity 110/120) can select from a plurality of delivery dates, times, time windows, and/or locations and the corresponding costs (if applicable) as part of an online shopping experience (e.g., after adding an item to a cart, at checkout, after shipment, and/or the like) and, responsive to a selection, the carrier system 100 and/or the retailer system/third party system 125 can provide confirmation of the selection, as is shown in FIG. 19F display 1925, and update the shipping information/data correspondingly for delivery at the specified date, time, and/or location with the corresponding cost.

b. Determination of Synchronized Delivery, Costs, and/or Delivery Criteria

FIG. 20 provides a flow diagram illustrating the steps that may be performed by the carrier system 100 and/or the retailer system/third party system 125 to determine (a) whether synchronized delivery with a stop creator shipment is possible (or probable), for example, to increase or decrease density (and/or influence delivery parameter selections) and (b) whether a delivery cost is appropriate according to various embodiments. The synchronization/density/cost analysis begins, for example, as shown at Block 2005, where the carrier system 100 and/or retailer system/third party system 125 (e.g., in communication with customer computing entities 110/120 and/or carrier systems 100) may include means, such as processor 205 and/or the like, for receiving the customer information/data and/or shipping information/data from the one or more retailer systems 125. In some embodiments, carrier system 100 may be configured for receiving customer location information/data indicative of a customer location, the customer location information/data, as discussed above, being one or more of entered information/data (e.g., login/password), customer profile information/data, or address information/data associated with a customer computing entity and/or the like.

Once the location information/data is received, the delivery address may be normalized. That is, as is shown at Block 2010, the carrier system 100 and/or retailer system/third party system 125 may include means for normalizing the delivery address. The normalization process may be implemented using software that corrects errors in the address information/data (e.g., spelling errors) and adds missing information/data (e.g., postal information) received from the retailer system 125. In one embodiment, the carrier system 100 and/or the retailer system/third party system 125 may maintain a database of ways that a particular address may have been represented in previous items (e.g., incorrect capitalization, “Street” versus “St.” versus “St”, misspellings). These different representations may be linked to a “normalized” address representation. The carrier system 100 and/or retailer system/third party system 125 may query this database with the customer information/data and/or shipping information/data received from the retailer system/third party system 125 and once a match is found, the linked normalized address is returned.

Using the normalized address, the carrier system 100 and/or retailer system/third party system 125 may include means for determining (a) whether synchronized delivery with one or more stop creator items is possible (or probable) to increase or decrease density and/or influence delivery parameter selections and (b) whether a cost is appropriate. For example, in some embodiments, a method for encouraging synchronized delivery of a prospective shipment may be utilized. Specifically, in one exemplary embodiments, encouraging synchronized delivery may comprise creating/accessing a plurality of address profiles using historical data, wherein each address profile identifies at least one of (a) a frequency of stops at an associated address, (b) costs associated with making a stop at the associated address and (c) a reputation of the associated address, receiving shipping information/data from a merchant/third party for a prospective shipment including a destination address, identifying a certain address profile associated with the destination address, applying business rules to the certain address profile to determine if the prospective shipment qualifies for an incentive. Additional information/data regarding the encouragement of synchronized delivery can be found in U.S. patent application Ser. No. 13/828,652, filed on Mar. 14, 2013, which is incorporated by reference herein in its entirety.

Specifically, in some embodiments, after identifying the appropriate customer profile based on the, for example, normalized customer information/data and/or shipping information/data, the carrier system 100 and/or the retailer system 125 can determine/identify expected, estimated, confirmed, and/or guaranteed pick-up or delivery times (including pick-up or delivery windows). In another embodiment, the carrier system 100 and/or the retailer system 125 can determine/identify expected, estimated, confirmed, and/or guaranteed pick-up or delivery dates and/or times (including pick-up or delivery windows) for unregistered customers and/or without identifying a corresponding customer profile. These determinations may be made for an item that is to be or is being transported by the carrier and/or for items that are being purchased or may be purchased from the retailer. In one embodiment, the carrier system 100 and/or the retailer system 125 can make these determinations, for example, based on historical information/data and/or dynamic information/data.

In some embodiments, determinations may be based on historical information/data. Accordingly, the carrier system 100 and/or retailer system/third party system 125 may include means for analyzing historical information/data to determine/identify expected, estimated, confirmed, and/or guaranteed pick-up and/or delivery dates and/or times (pick-up and/or delivery information/data). In some embodiments, the carrier system 100 and/or the retailer system/third party system 125 may be configured for populating (e.g., via the Historical Analysis Module) a historical database to indicate when (e.g., dates and/or times) and for how much an item may be delivered to various addresses.

In one embodiment, to create and/or maintain the historical database, carrier system 100 and/or retailer system/third party system 125 may include means, such as processor 205 and/or the like, for (e.g., via the Historical Analysis Module) applying business rules to historical information/data associated with some or all of the addresses serviced by the carrier. In various embodiments, delivery address profiles may be established. The delivery address profile information/data may link a particular address to other nearby addresses (e.g., a close residential address, same neighborhood, commercial addresses within the same building, an apartment complex, duplex, along the same route, and/or the like). This linking may relate to a service point, which identifies where a service provider may stop to service one or more addresses. For example, a service provider may make a single stop (e.g., at a service point) to make deliveries to multiple addresses such as an apartment complex, shopping mall, neighborhood, and/or the like. Similarly, a service provider may make a single stop for a specific address such as a residence, office suite, and/or the like. The delivery address profile may include a list of consignees receiving items at the address, frequency of deliveries to or pick-ups from the address and/or nearby addresses (e.g., average daily volume, average weekly stops), typical days of delivery and/or pick-up (e.g., Monday, Tuesday, Wednesday, Thursday, Friday, Saturday, Sunday, and/or the like), costs associated with making a delivery to the address and/or nearby addresses, whether deliveries require consignee signatures or allow driver release, delivery type (e.g., residential or commercial), and stop reputation for the associated addresses or nearby addresses. The stop reputation may include information/data regarding missed deliveries, claims, delinquencies, and/or the like. Additional information/data may include business names, suite, floor, building, apartment number, and/or the like.

The delivery address profile may be based on information/data collected over a particular time frame/period such as, for example, 3 months, 6 months, 1 year, and/or the like. In some embodiments, the delivery address profile may be adjusted based on the time of year (e.g., seasons, holidays, weather, temperatures, and/or the like). An exemplary scenario is provided below with regard to the historical database.

In addition to the delivery address profile, a pick-up location profile may also be created. The pick-up location profile may include characteristics of the fulfillment or drop ship location as well as the shipper. The pick-up location profile information/data may link a particular address to other nearby addresses (e.g., a close residential address, commercial addresses within the same building, an apartment complex, duplex, along the same route, and/or the like). The pick-up location profile may include a list of consignors sending items from the address, frequency of deliveries to or pick-ups from the address and/or nearby addresses (e.g., average daily volume, average weekly stops), typical days of delivery and/or pick-up (e.g., Monday, Tuesday, Wednesday, and/or the like), costs associated with making a pick-up from the address and/or nearby addresses, delivery type (e.g., residential or commercial), and stop reputation for the associated addresses and/or nearby addresses. The stop reputation may include information/data regarding missed pick-ups, claims, delinquencies, and/or the like. Additional information/data may include business names, suite, floor, building, apartment number, and/or the like.

Using various business rules, carrier system 100 and/or retailer system/third party system 125 may include means, such as processor 205 and/or the like, for (e.g., via the Historical Analysis Module) indicating in, or in some embodiments, in the event the appropriate information/data is available, extracting and/or accessing from the historical database, the cost for deliveries on specified days, dates, times, and/or time windows. For example, the business rules may establish a threshold average daily volume or average weekly deliveries to or pick-ups from the address or cumulative stops to nearby addresses as a basis for the costs. In some embodiments, to determine accurate costs and/or fee estimates associated with particular addresses or geographic areas, the carrier system 100 may be configured to assign parameters to a geographic area. For example, a geographic area may first be defined and information/data may then be collected that is associated with the geographic area. After defining the geographic area and collecting relevant information/data, an estimated cost associated with a delivery vehicle visit to a location within the geographic area can be determined, based, for example, at least in part on the information/data gathered. Additional information/data regarding determining costs to a geographic area may be found in U.S. patent application Ser. No. 12/553,191, filed on Sep. 3, 2009, which is incorporated by reference herein in its entirety.

Furthermore, in some embodiments, costs may be graduated based on the different thresholds. For example, business rules may set one cost for a given volume threshold and a different cost for a greater volume threshold. Similarly, different costs may be given for a threshold volume associated with a particular address versus the same cumulative volume associated with nearby addresses. It should be noted that in some embodiments, the carrier system 100 and/or retailer system/third party system 125 may perform the historical cost analysis “on the fly” as opposed to populating a separate historical database. It should be noted that business rules may be adjusted based on characteristics of the shipper or the consignee—high claims, high volume, low volume, and/or the like. Furthermore, the business rules may have a hierarchy. Some business rules may take precedence over other business rules. For example, a cost may be provided even if an address match is not found if there is a desire to increase delivery volume in a particular area. In some embodiments characteristics of the shipment may also impact the cost such as the size, weight, number of packages, and/or the like. As will be recognized, a variety of other techniques and approaches can be used to adapt to various needs and circumstances.

In some embodiments, determinations may be based on dynamic and/or predicted information/data. As such, the carrier system 100 and/or retailer system/third party system 125 may include means for analyzing dynamic information/data to determine/identify expected, estimated, confirmed, and/or guaranteed pick-up and/or delivery dates, times, time windows and/or associated costs (pick-up and/or delivery information/data). In some embodiments, the carrier system 100 and/or retailer system/third party system 125 may include means for populating (e.g., via the Historical Analysis Module) a dynamic database to indicate when (e.g., dates and/or times) and for how much an item may be delivered to various addresses. This database may be updated continuously, regularly, periodically, and/or in response to certain triggers (e.g., as new items are received).

To populate the dynamic database, the carrier system 100 and/or the retailer system 125 may be configured to access PLD information/data maintained by the carrier system 100. As will be understood by those skilled in the art, carriers may maintain PLD information/data for each of the items that are forecasted to be delivered by the delivery network. This dynamic information/data may include information/data for each forecasted/predicted shipment such as a ship date, an origin address, a delivery address, a service level, a forecasted and/or predicted delivery date/time, a unique identifier, exception information/data, and/or the like. Using this information/data, carrier system 100 and/or retailer system/third party system 125 may include means, such as processor 205 and/or the like, for determining which days and times items are already forecasted/predicted for delivery to the various addresses serviced by the carrier.

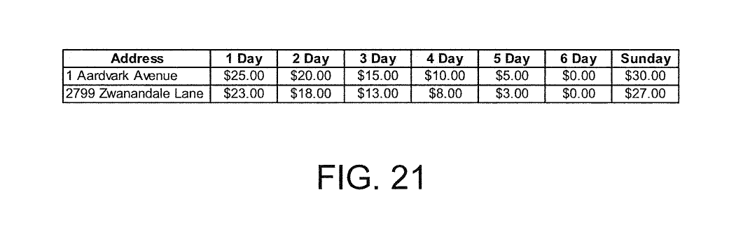

The carrier system 100 and/or retailer system/third party system 125 may include means for (e.g., via the Dynamic Analysis Module) applying business rules to the PLD information/data to determine whether existing deliveries are forecasted for the address or a nearby address on one or more particular dates and/or at one or more times on those dates. Thus, if the online retailer tenders the shipment to the carrier with sufficient time to be delivered on one of those particular dates in which synchronization can occur or density can be increased, a cost may be provided. FIG. 21 illustrates a possible structure for a PLD delivery date and cost database. In the illustrated embodiment, an address is provided and an indication as to how much it will cost to delivery an item on Day 1, Day 2, Day 3, Day 4, Day 5, Day 6, Sunday, and/or the like (including time windows, periods, and/or frames on each of those days). For example, delivery to “1 Aardvark Avenue” within two days from shipment may be $20, while four days may be $10. It should be noted that additional days and/or time frames/periods may be provided in the dynamic database as desired. Further, the historical database may also include such pick-up and/or delivery information/data.

In various embodiments, each “Day and/or Time” indication may be a tendered date and/or time from the retailer system/third party system 125 to the carrier, or a delivery date and/or time to the consignee. In various embodiments, separate information/data sets may be created for address matches versus nearby address matches. These separate information/data sets may be associated with different cost amounts. It should be noted that in some embodiments, the carrier system 100 and/or the retailer system/third party system 125 may perform the dynamic cost analysis “on the fly” by a system in real time utilizing historical, dynamic (real-time updates) and/or predicted information/data stores as opposed to populating a separate dynamic database.

In some embodiments, determination may be based on historical information/data and dynamic information/data. For example, in some embodiments, the historical information/data and the dynamic information/data may be combined into a single database. For example, the database may have fields for each address indicating various pick-up and/or delivery dates, times, time windows and/or associated costs. In various embodiments, business rules may be utilized and/or applied to identify different costs for different combinations of historical and dynamic information/data. That is, the carrier system 100 and/or retailer system/third party system 125 may include means for utilizing and/or applying one or more business rules to identify different costs for different combinations of historical and dynamic information/data For example, a business rule may identify cost “A” when the historical information/data shows a cost but the dynamic information/data shows no cost. Alternatively, a business rule may identify cost “B” when the historical information/data shows a cost and certain days and/or times. Of course any combination of dates, times, service levels and/or associated costs may be provided.

Returning to FIG. 20, as discussed above in block 2015, the carrier system 100 and/or retailer system/third party system 125 may include means for querying one or more of (a) a historical database, (b) a dynamic database, (c) a combined database, and/or (d) the like to determine if a cost is available. In response to the query, costs including any incentives that may be available and one or more delivery criteria associated with such costs may be received. As such, as is shown in Block 2020, the carrier system 100 and/or retailer system/third party system 125 may include means for receiving costs including any incentives that may be available and one or more delivery criteria.

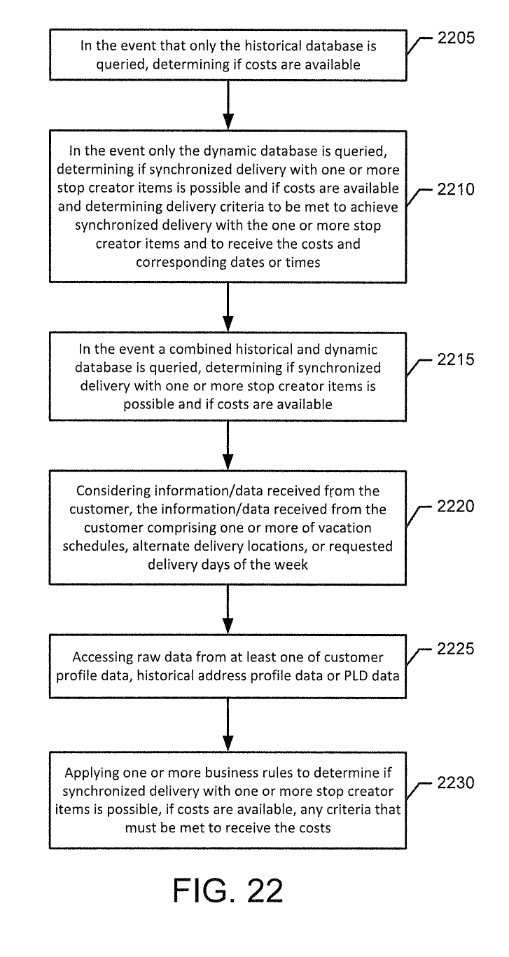

FIG. 22 shows a process including steps associated with determining those costs and incentives that may be available, as well as the determination of any delivery criteria. As such, in the event that only the historical database is queried, as is shown in Blok 2205, the carrier system 100 and/or retailer system/third party system 125 may include means for determining if costs are available for the particular address or area and/or the corresponding dates, times, and/or time windows. In various embodiments, the query result may indicate (a) whether costs are available, (b) the type of costs—address match or nearby address match with an anticipated stop creator shipment, (c) the actual costs, (d) the corresponding dates and/or times, and/or (e) the like.

In the event only the dynamic database is queried, as is shown in Block 2210, the carrier system 100 and/or retailer system/third party system 125 may include means for determining if synchronized delivery with one or more stop creator items are possible (or probable) and costs are available for the particular address or area to increase or decrease density and/or influence delivery parameter selections. In some embodiments, the carrier system 100 and/or retailer system/third party system 125 may include means for determining delivery criteria that may need to be met to achieve synchronized delivery with the one or more stop creator items and to receive the costs and corresponding dates and/or times. These delivery criteria may be based on the ability to synchronize the delivery with forecasted deliveries to the particular address or nearby addresses and may include specific delivery dates or ranges of dates. This may be performed in an effort to increase or decrease density and/or influence delivery parameter selections by uses.

In some embodiments, as is shown at Block 2215, in the event a combined historical and dynamic database is queried, the carrier system 100 and/or retailer system/third party system 125 may include means for determining (a) if synchronized delivery with one or more stop creator items is possible (or probable) to increase or decrease density and/or influence delivery parameter selections and (b) if costs are available for the particular address or area. The carrier system 100 and/or the retailer system/third party system 125 may also determine delivery criteria that may need to be met to achieve synchronized delivery and/or receive the costs and corresponding dates and/or times. If the costs are based on historical information/data, there may not be any separate delivery criteria necessary to receive the costs. Alternatively, if the dynamic information/data is relied upon to identify costs, the delivery criteria may be based on the ability to synchronize the delivery with forecasted deliveries to the particular address or nearby addresses (e.g., collectively stop creator shipment) and may include specific delivery dates/times or ranges of dates/times.

Independently or in combination with the queries to a historical and/or dynamic database, the carrier system 100 and/or the retailer system 125 may also consider information/data received from the customer (e.g., a customer profile). That is, as is shown in Block 2220, the carrier system 100 and/or retailer system/third party system 125 may include means for considering information/data received from the customer. This information/data may include vacation schedules, alternate delivery locations, requested delivery days of the week, and/or the like. Processes that may be used in capturing and storing this type of information/data is described in co-pending U.S. patent application Ser. No. 13/174,290, filed Jun. 30, 2011 and entitled “Customer Controlled Management of Items,” which is incorporated by reference herein in its entirety. This application describes a registration process and operations of various customer delivery programs that may operate in conjunction with embodiments of the present invention.

It should be noted that in various embodiments, the historical cost analysis and/or dynamic synchronization/density/cost analysis may be performed by a system in real time utilizing historical, dynamic (real-time updates) and/or predicted information/data stores as opposed to querying existing (static) databases. In either case, as is shown in Blocks 2225 and 2230 respectively, the carrier system 100 and/or retailer system/third party system 125 may include means for accessing the appropriate raw information/data (e.g., customer profile data, historical address profile information/data and/or PLD data, and/or the like) and applying business rules as generally discussed above with reference to the historical database and the dynamic database to determine (a) if synchronized delivery with one or more stop creator items are possible (or probable) to increase or decrease density and/or influence delivery parameter selections and (b) if costs are available. Furthermore, as discussed above, the carrier system 100 and/or the retailer system 125 may also determine any criteria that must be met to receive the costs.

Returning now to FIG. 20, once the determination process is performed (e.g., synchronization/density/cost analysis is performed), a comparison may be made of the delivery criteria against the promised delivery dates, times, and/or time windows. As such, as is shown in Block 2025, the carrier system 100 and/or retailer system/third party system 125 may include means for comparing the delivery criteria against the promised delivery dates, times, and/or time windows provided by the retailer system 125 (or determined by the carrier system 100). Using this information/data, the costs may be filtered. Accordingly, the carrier system 100 and/or retailer system/third party system 125 may include means for filtering the cost results to meet the promised dates, times, and/or time windows. For example, if the promised delivery date is on or before February 1 and the delivery criteria shows possible costs for delivery dates of January 29, January 31, and February 3, this comparison would filter out the February 3 date. In the event the customer information/data and/or shipping information/data received from the retailer system 125 does not include a promised dates, times, or time windows, the carrier system 100 and/or the retailer system/third party system 125 may not perform this step. Instead, all costs, dates, times, and/or time windows identified in the analysis may be provided.

After the synchronization/density/cost analysis is performed, as is shown at Block 2030, the carrier system 100 and/or retailer system/third party system 125 may include means for communicating pick-up and/or delivery information/data (e.g., comprising information/data) to the one or more retailer system/third party system 125 for the received address, which is received by the retailer system 125. The pick-up and/or delivery information/data may be communicated using an API, user interface, integrated software, pop-up windows or other communication protocols or paths.

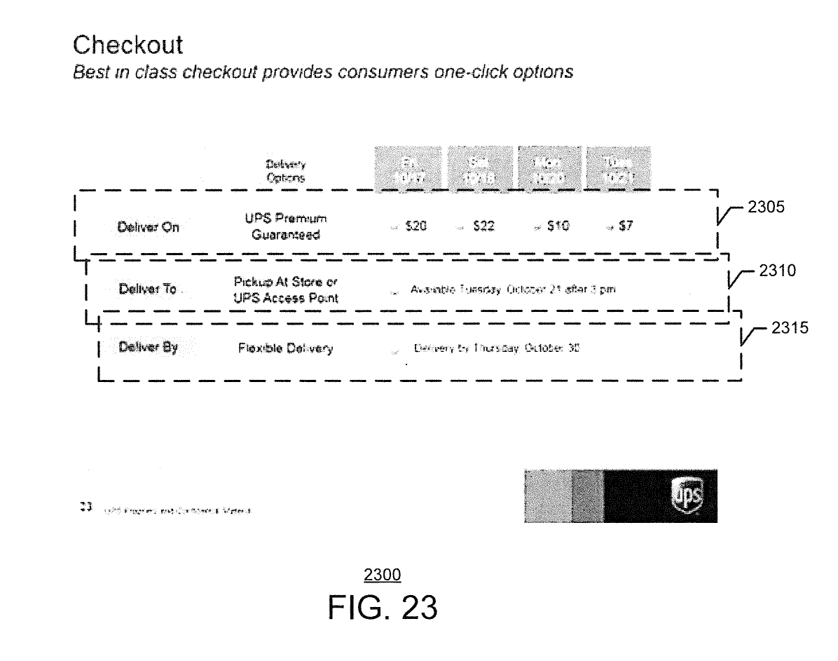

FIG. 23 shows a display 2300 that may be provided to a customer (e.g., operating customer computing entities 110/120) showing various communicating pick-up and/or delivery information/data after synchronization/density/cost analysis. For example, a customer (e.g., operating customer computing entities 110/120) may be provided with options available for selection including one or more delivery times/windows and, in some embodiments, the corresponding costs (if applicable) as part of an online shopping experience (e.g., after adding an item to a cart, at checkout, after shipment, and/or the like). Specifically, display portion 2305 shows one or more customer-selectable delivery windows (e.g., Fri 10/17, Sat 10/18, Mon 10/20, and Tues 10/21), which may be the result of results returned from querying the historical database and/or the dynamic database. That is, the costs shown associated with the selection of each of the four delivery windows may be the result of one or both of determining if costs are available for the customer's address or area and/or the corresponding dates, times, and/or time windows and determining if synchronized delivery with one or more stop creator items is possible or probable and the costs for the customer's address or area, the costs, in some embodiments, acting to increase or decrease density and/or influence delivery parameter selections.

Display portion 2310 may, in some embodiments, be provided to the customer in addition to, or in some embodiments, alone, in the event that a customer does not wish to pay for expedited delivery options but does not want to wait for delivery to the customer's address. Display portion 215 may be provided to the customer in addition to, or in some embodiments, alone, in the event that a customer does not wish to pay for expedited delivery options and is willing to wait for normal delivery.

In some embodiments, the pick-up and/or delivery information/data may simply indicate costs, dates, times, and/or time windows, while in other embodiments the pick-up and/or delivery information/data may include the actual costs including discount amounts, discount percentages, and/or the like. In further embodiments, the pick-up and/or delivery information/data may include delivery criteria that must be met to receive the determined/identified cost. For example, the pick-up and/or delivery information/data may indicate a required tender date to receive the cost. As will be recognized, a variety of other techniques and approaches can be used to adapt to various needs and circumstances.

In various embodiments, the pick-up and/or delivery information/data may indicate the tendered date and associated tender locations for the shipment to receive the cost. The tender locations may be fulfillment centers or drop-ship locations for the on-line retailer, drop boxes, or other carrier pick locations. The carrier system 100 and/or retailer system/third party system 125 may include means for determining which tender locations to offer based on a variety factors such as, for example, volume in delivery lanes associated with the different locations, time-in-transit, proximity to delivery address, cost associated with the pick-up, and/or the like.

### 7. Authenticating Customers

In some embodiments, an interface (e.g., browser, dashboard, application from a carrier and/or retailer) in communication with the carrier system 100 and/or retailer system/third party system 125 can be used to provide one or more delivery benefits, including in some examples, providing and receiving selection of, for example, one or more expected, estimated, confirmed, and/or guaranteed pick-up and/or delivery dates, times, time windows and/or associated costs (pick-up and/or delivery information/data), as discussed above and/or the bypassing of some portion of the validation steps conventionally required in the selection thereof. For example, a customer (e.g., a customer or customer representative operating a consignee computing entity 110 or consignor computing entity 120) may access the interface (e.g., browser, dashboard, application from a carrier and/or retailer) in communication with the carrier system 100 and/or retailer system/third party system 125, while for example, shopping online via the retailer's website, application, and/or the like, to view an item. In order to be provided with, one or more expected, estimated, confirmed, and/or guaranteed pick-up and/or delivery dates, times, time windows and/or associated costs (pick-up and/or delivery information/data) for the item, before, during, and/or after purchase, the customer may additionally access an interface (e.g., browser, dashboard, application from a carrier and/or retailer) in communication with the carrier system 100 without having to sign in, provide additional verification, credentials, usernames, passwords, and/or the like.

In a first exemplary embodiment, retailer system/third party system 125 may enroll an authenticated user in a carrier's customer pick-up, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login information/data associated with the retailer system/third party system 125 (e.g., login to www.retailer.com and/or the like), or other customer information/data (e.g. personal identification, address verification, financial, mobile device, etc.) associated with the retailer system.

In a second exemplary embodiment, a retailer system/third party system 125 may enroll a non-authenticated or a verified user in a carrier's customer pick-up, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login information/data associated with the retailer system/third party system 125 (e.g., login to www.retailer.com and/or the like), or other customer information/data (e.g. personal identification, address verification, financial, mobile device, etc.) associated with the retailer system.

In a third exemplary embodiment, a retailer system/third party system 125 may enroll an authenticated user in a carrier's customer pick-up, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login and password information/data associated with the carrier system 100, or, in some embodiments, other customer information/data (e.g. personal identification, address verification, financial, mobile device, etc.) associated with the carrier system.

In a fourth exemplary embodiment, a retailer system/third party system 125 may enroll a non-authenticated or a verified user in a carrier's customer pick-up, delivery, and/or returns program (e.g., Carrier Program) using, for example, an Accelerated Enrollment API (e.g., Carrier Accelerated Program Enrollment API) from the carrier system 125. Subsequent to the accelerated enrollment, delivery window information/data may be returned, for example, to the carrier system 125 using a carrier system API. The user may then access the carrier system 100 (e.g., Carrier.com, m.Carrier.com, Carrier.com/m) with a, for example, mobile application provided by the carrier system 100 (e.g., the Carrier mobile App) by providing login and password information/data associated with the carrier system 100, or, in some embodiments, other customer information/data (e.g. personal identification, address verification, financial, mobile device, etc.) associated with the carrier system.

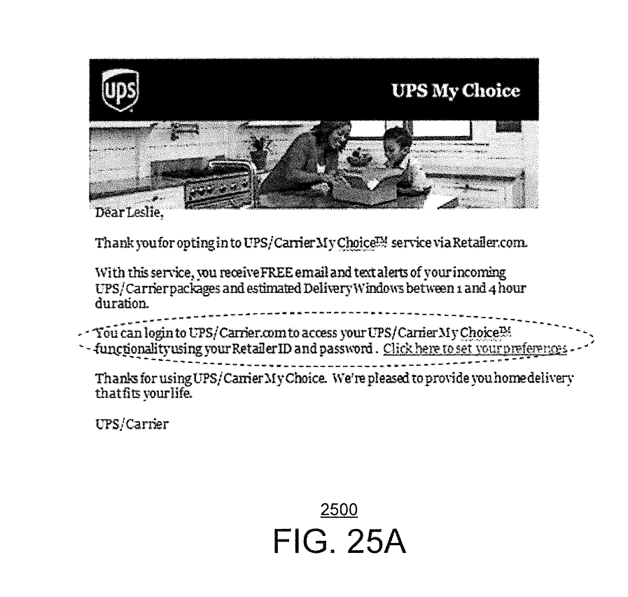

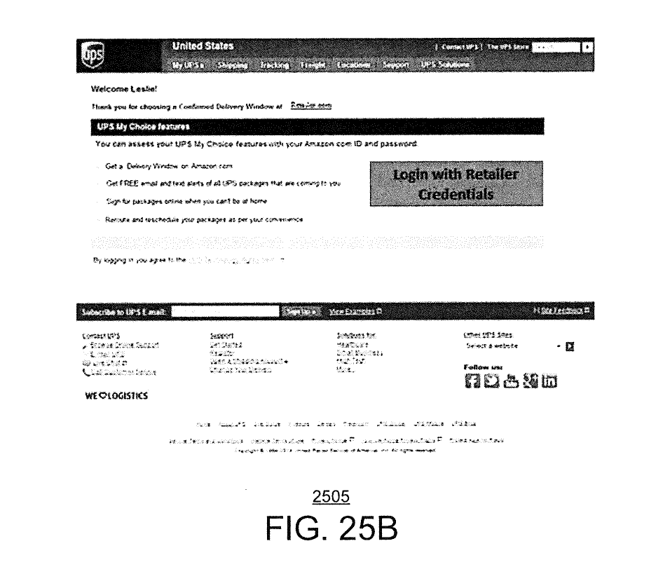

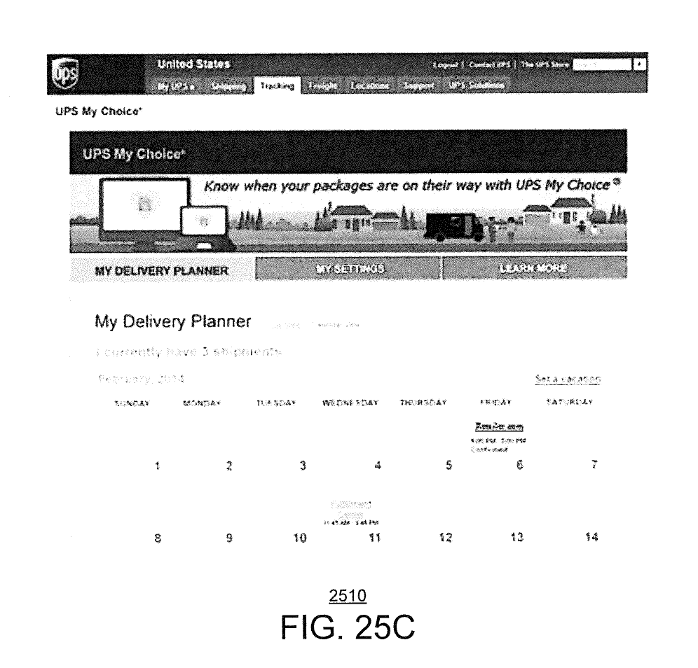

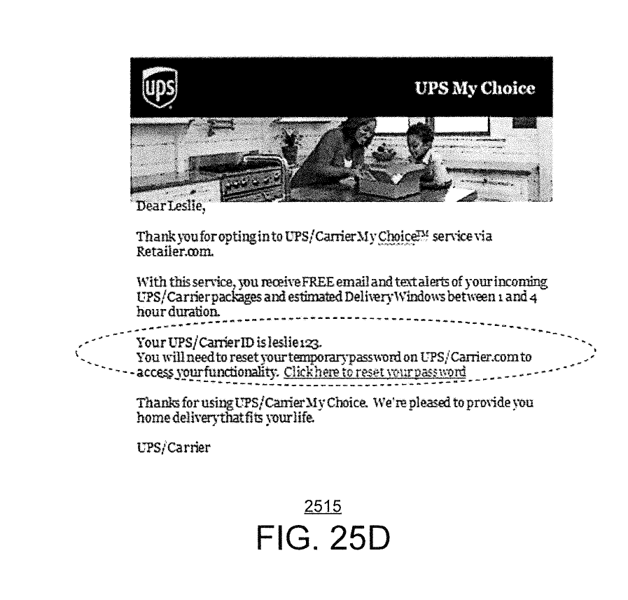

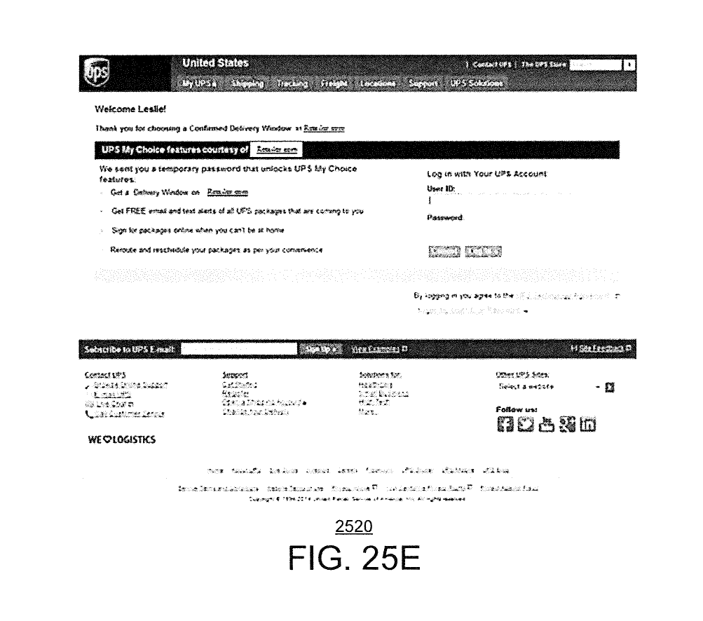

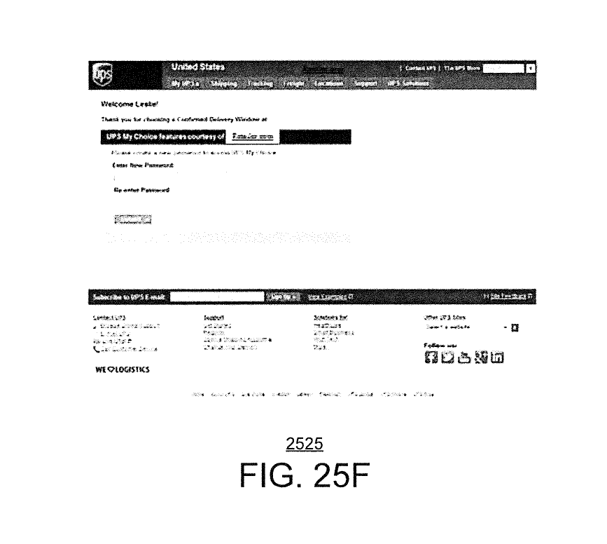

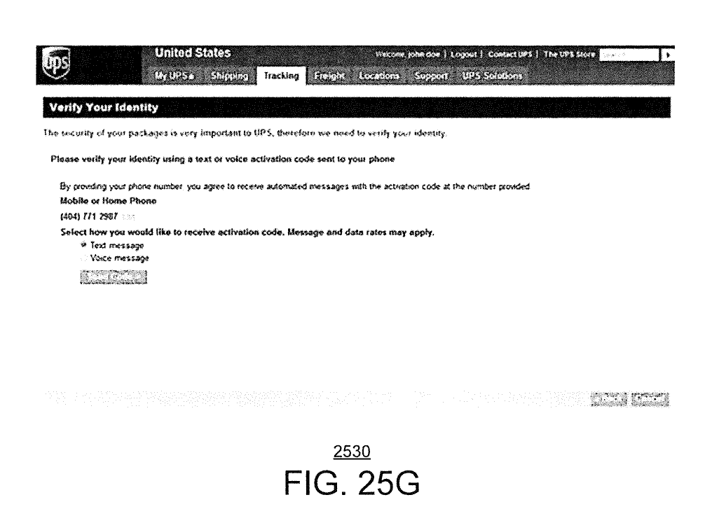

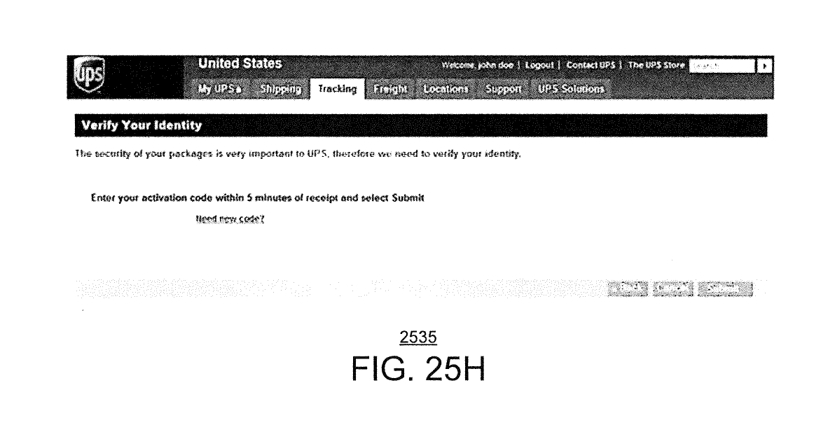

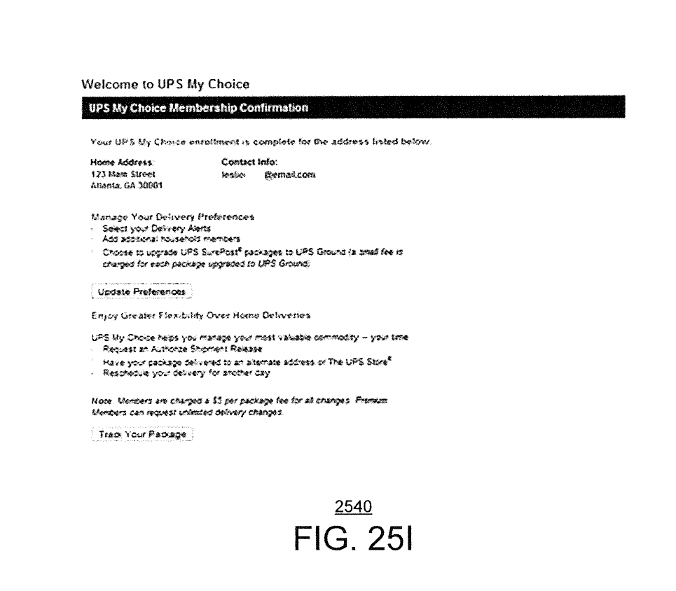

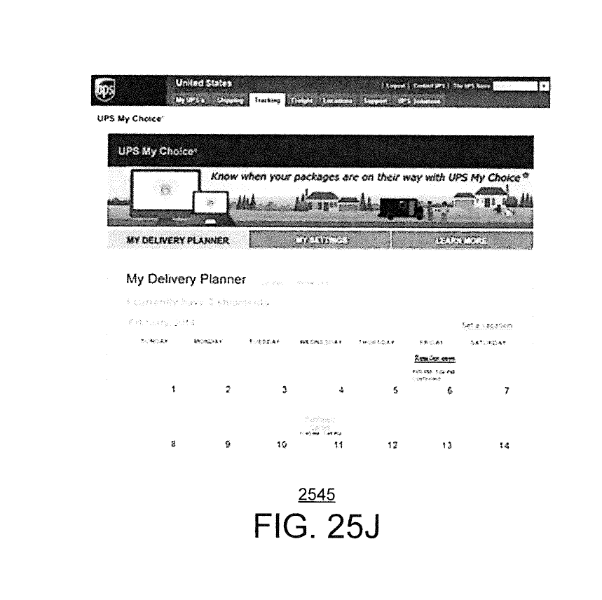

FIG. 22 shows a flowchart illustrating a process that may be performed by a retailer system/third party system 125 and/or a carrier system 100 for providing one or more delivery benefits to, for example, online shoppers utilizing any of the retailer's website (e.g., www.retailer.com), a retailer login API, and/or a carrier API (e.g., Carrier Accelerated Program Enrollment API). In some embodiments, delivery benefits may include, but are not limited to, providing one or more expected, estimated, confirmed, and/or guaranteed pick-up and/or delivery dates, times, time windows and/or associated costs (pick-up and/or delivery information/data) for selection and/or bypassing some portion of the validation steps in the selection thereof, as well as receiving free email or text alerts related to any incoming packages, changing, viewing, scheduling the delivery windows and/or the like. The flowchart shown in FIG. 24 will be described with reference to example displays 2500-2545, shown in FIGS. 25A-25J. FIGS. 25A-25J show example displays 2500-2545 that may be presented by one or more display screens of one or more devices, such as those used by a user, such as a customer, retailer, and/or the like, which as described above, may be referred to herein as a consignee computing device 110, consignor computing entity 120, and/or the like. Again, while the example displays 2500-2545 are configured to be shown on a computer monitor, laptop screen, tablet computer, or other device having similar dimensions, similar interfaces may be utilized with other types of devices (e.g., mobile telephone, “smart phone,” etc.) discussed herein and modified accordingly (e.g., for screen size, input device compatibly, ease of use, etc.). Note that the portion of the displays described herein may be labeled differently and not necessarily as shown.

In some embodiments, a retailer system/third party system 125 (e.g., in communication with customer computing entities 110/120 and/or carrier systems 100), as is shown in operation 2205, may include means, such as processor 205 and/or the like, for enrolling/registering authenticated and/or non-authenticated customers into a carrier's customer pick-up, delivery, and/or returns program. As used herein, an authenticated customer may be a customer with whom the retailer has had past interactions and/or has confirmed the customer's identity, address, and/or the like. Thus, a non-authenticated customer may be a customer with whom the retailer has not had past interactions and/or has not confirmed the customer's identity, address, and/or the like. As described previously, authenticated customers may have access to different options that non-authenticated members do not have (including one, some, and/or all of the above described features). The enrollment/registration may be similar to that previously described in the section entitled 1. Registration.

The retailer system/third party system 125 may indicate to the carrier system 100 that the customer has been authenticated by setting a flag in the communication or notification to the carrier system 100. As such, in some embodiments, a retailer system/third party system 125 (e.g., in communication with customer computing entities 110/120 and/or carrier systems 100), as is shown in operation 2410, may include means, such as processor 205 and/or the like, for providing an indication to the carrier system 100, or in some embodiments, to a carrier's API, that the customer has been authenticated by setting a flag in the communication or notification. In some embodiments, by being authenticated, a customer may be registered/enrolled, bypassing the validation/fraud operations and/or processes that may be required of a non-authenticated customer. The retailer system/third party system 125 may be configured to subject non-authenticated customers to additional steps and/or provide a subs-set of all of the various options until they have been authenticated by the carrier system 100 and/or the retailer system/third party system 125. In some embodiments, the retailer system/third party system 125 may be configured for enabling an activation and/or verification process requiring, for example, login or customer information/data associated with customer information/data of the retailer system to be captured by the carrier system.

For example, FIGS. 25A-25C shows displays 2500-2510 that may be displayed in response to an indication that the customer is authenticated. Whereas FIGS. 25D-25J show displays 2515-2545, which may be displayed in response to a notification that the customer is not authenticated. As shown in FIG. 25A, display 2500 shows a display that may be displayed by a carrier system 100, a carrier system's API and/or the like indicating that the authenticated user may access the carrier system 100 (e.g., Carrier.com, m.Carrier.com, Carrier.com/m) using their retailer ID and password. As shown, display 2500 may display “Click Here to set your preferences” and/or the like and be configured to receive selection of the user's indication to proceed to the carrier system 100. FIG. 25B shows display 2505 which may be displayed upon reception of user selection and be configured to receive the retailer login information/data (e.g., username and password) to access the carrier system 100. FIG. 25C then shows a display 2510 which may be displayed upon reception of the user's retailer login information. That is, the user's access to the carrier system 100 (e.g., Carrier.com, m.Carrier.com, Carrier.com/m) may be, for example, a calendar labeled “My Delivery Planner” displaying one or more delivery windows (e.g., retailer.com, 1:00 PM-3:00 PM, confirmed). In other exemplary embodiments, one or more of the user's additional expected, estimated, confirmed, and/or guaranteed pick-up or delivery times (including pick-up or delivery windows) for each of one or more other participating retailer systems 125 may be displayed.

FIGS. 25D-25J shows displays 2515-2545 that may be displayed in response to an indication that the customer is not authenticated. As shown in FIG. 25D, display 2515 shows a display that may be displayed by a carrier system 100, a carrier system's API and/or the like indicating that the authenticated user may access the carrier system 100 (e.g., Carrier.com, m.Carrier.com, Carrier.com/m) using their carrier system 100 information/data. As shown, display 2515 may display the user's carrier system ID and a statement such as “You will need to reset your temporary password on Carrier.com to access your functionality. Click Here to set reset your password” or any statement indicating the use of the carrier system ID will be necessary to access the carrier system. The display may also be configured to receive selection of the user's indication to proceed to the carrier system 100. FIG. 25E shows display 2520 that may be displayed subsequent to selection in the display 2515 and configured to receiving a User ID and Password associated with the carrier system 100. The display may further indicate that a temporary password has been sent to the user. FIG. 25F shows display 2525 which may be displayed once the user enters the User ID and temporary password in display 2520 and selects login. Display 2525 may be configured to receive a new password by for example, indicating to the user to “Enter New Password” and “Re-Enter Password.”

FIG. 25G shows display 2530 which may be displayed once the user enters a new password. Display 2530 may be configured to provide verification of the user's identity. For example, as shown in FIG. 25G, display 2530 may be configured to display, or in some embodiments, request, a phone number and request a selection indicating how the user would like to receive an activation code (e.g., text message or voice message). Display 2300 may be configured to receive an indication to send the verification code once the user submits the requested information. FIG. 25H shows display 2535 which may be displayed subsequent to the user's input of their phone number and preferred method of receiving the verification code. The carrier system 100 may be configured to receive the user information/data and send the verification code via the selected means (e.g., text message or voice message). As shown, display 2335 may be configured to receive the activation code. Moreover, display 2535 may be configured to receive a selection form the user indicating a need to resend the activation code.

FIG. 25I shows display 2540 which may be displayed once the user enters the activation code. As shown in FIG. 25I, display 2540 may be configured to display the user's home address, contact information/data and/or the like. Display 2540 may further be configured to allow the user to manage their delivery preferences (e.g., update preferences, select delivery alerts, add additional household members, to choose an upgraded membership level (e.g., Carrier SurePost). Display 2540 may further be configured to enable the user to track a package, request an Authorize Shipment Release, have a package delivered to an alternate address or a store associated with the carrier system 100 (e.g., The Carrier Store), and/or reschedule their delivery to another day. FIG. 23J shows display 2345 which may be displayed that may be displayed up reception of the login information. That is, the user's access to the carrier system 100 (e.g., Carrier.com, m.Carrier.com, Carrier.com/m) may be, for example, a calendar labeled “My Delivery Planner” and displaying one or more delivery windows (e.g., retailer.com, 1:00 PM-3:00 PM, confirmed). In other exemplary embodiments, one or more of the user's additional expected, estimated, confirmed, and/or guaranteed pick-up or delivery times (including pick-up or delivery windows) for each of one or more other participating retailer systems 125 may be displayed. As is shown, in an instance in which a retailer system/third party system 125 (e.g., in communication with customer computing entities 110/120 and/or carrier systems 100) provides an indication to the carrier system 100 that the customer has been authenticated by, for example, setting a flag in the communication or notification, many steps in the verification process may be bypassed.

Returning to FIG. 24, in some embodiments, a retailer system/third party system 125 (e.g., in communication with customer computing entities 110/120 and/or carrier systems 100), as is shown in operation 2215, may include means, such as processor 205 and/or the like, for initiating a request to the carrier system 100 for one or more expected, estimated, confirmed, and/or guaranteed pick-up and/or delivery dates, times, time windows and/or associated costs (pick-up and/or delivery information/data). For example, when a customer (e.g., operating a customer computing entity 110/120) launches an application or interface, logs into an account, selects an item for placement into an electronic shopping cart, begins to complete a sale or purchase transaction for an online transaction, and/or the like, a retailer system/third party system 125 (e.g., in communication with customer computing entities 110/120 and/or carrier systems 100), as is shown in operation 2420, may include means, such as processor 205 and/or the like, for providing the carrier system 100 with customer information/data and/or shipping information/data associated with the customer and/or item.

In response to receiving the customer information/data and/or the item information/data, the carrier system 100 may identify a customer profile matching the same as described in section 2. Customer and Item Matching. That is, in some embodiments, a carrier systems 100 (e.g., in communication with customer computing entities 110/120 and/or retailer system/third party system 125), as is shown in operation 2425, may include means, such as processor 205 and/or the like, for identifying a customer profile matching or nearly matching the customer information/data of shipping information/data provided from the retailer system/third party system 125. After identifying the correct customer profile, in some embodiments, a carrier systems 100 (e.g., in communication with customer computing entities 110/120 and/or retailer system/third party system 125), as is shown in operation 2430, may include means, such as processor 205 and/or the like, for determining or identifying one or more expected, estimated, confirmed, and/or guaranteed pick-up and/or delivery dates, times, time windows and/or associated costs (pick-up and/or delivery information/data) based at least in part on the customer information/data and/or the shipping information/data as described in section 5. Pick-up/Delivery Times or 6. Enhanced Delivery Time/Window and Cost Concepts.

For example, the carrier system 100 and/or the retailer system/third party system 125 may determine/identify or identify multiple expected, estimated, confirmed, and/or guaranteed pick-up and/or delivery dates, times, time windows and/or associated costs (pick-up and/or delivery information/data). In an online environment, such as when for example a customer may be shopping online via the retailer's website, application, and/or the like, this may allow for customers to select a specific expected, estimated, confirmed, and/or guaranteed pick-up and/or delivery dates, times, time windows and/or associated costs before, during, or subsequent to selection of item, placement of an item in a shopping cart, a checkout process, shipping of the item and/or the like. For example, if the carrier system 100 and/or the retailer system/third party system 125 determines that the expected, estimated, confirmed, and/or guaranteed delivery time is, for example, 2:00 pm and/or that the applicable delivery window is 1:00 pm-3:00 pm, the carrier system 100 and/or the retailer system/third party system 125 can provide this service at no additional charge or for any amount desired or determined. However, the carrier system 100 and/or the retailer system/third party system 125 can also provide other delivery times and time windows, such as an expected, estimated, confirmed, and/or guaranteed delivery time of 11:00 am (or delivery window 10:00 am-12:00 pm) and/or an expected, estimated, confirmed, and/or guaranteed delivery time of 6:00 pm (or delivery window 5:00 pm-7:00 pm), with a cost/charge corresponding to each time or time window. As such, customers are provided with greater flexibility over their pick-up and delivery services.

In some embodiments, even if a customer has not yet been registered/enrolled (e.g., a customer profile has not been created), the carrier system 100 may be able to determine/identify delivery times (including pick-up or delivery windows) from the customer information/data and/or shipping information/data. As previously indicated, this determination/identification can be based on historical information/data from previous visits to the customer's location, forecasted delivery volumes for the day and/or time of delivery, weather, and/or the like.

In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2235, may include means, such as processor 205 and/or the like, for allowing for a customer to select a specific delivery time or delivery time window and, some embodiments, cost, before an item is purchased, as part of the checkout process, after an item has been received by the carrier for transport, and/or the like.

In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2240, may include means, such as processor 205 and/or the like, for calculating and/or providing costs associated with each delivery time or time window as described in section 5. Pick-up/Delivery Times or 6. Enhanced Delivery Time/Window and Cost Concepts. This approach may be used to provide customers with greater flexibility over their pick-up and delivery services.

In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2245, may include means, such as processor 205 and/or the like, for providing information/data indicative of the expected, estimated, confirmed, and/or guaranteed pick-up or delivery times or time windows configured for display or view and/or selection by customers following, for example, the processes and operations described in section 5. Pick-up/Delivery Times or 6. Enhanced Delivery Time/Window and Cost Concepts. For example, as shown in FIG. 25D, a customer (e.g., operating customer computing entities 110/120) may select from a one or more or, in some embodiments, a plurality of delivery times/windows and, in some embodiments, the corresponding costs (if applicable) as part of an online shopping experience (e.g., after adding an item to a cart, at checkout, after shipment, and/or) the like. Latency may be reduced the earlier the appropriate information/data is provided to determine/identify the delivery times or windows. In some embodiments, a retailer system/third party system 125 (e.g., in communication with customer computing entities 110/120 and/or carrier systems 100) or a carrier systems 100 (e.g., in communication with customer computing entities 110/120 and/or retailer system/third party system 125), as is shown in operation 2450, may include means, such as processor 205 and/or the like, for, responsive to a selection, updating the shipping information/data correspondingly for delivery at the specified time or within the specified window.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for determining a cost for delivering an item to a customer, the method comprising:
receiving, via one or more processors, customer location data indicative of a customer location, the customer location data selected from the group consisting of entered data, customer profile data, and address data associated with the customer; and
determining, via the one or more processors, one or more time frames from a plurality of carrier time frames in which delivery of the item is available based on the customer location;
querying, via the one or more processors, at least one selected from the group consisting of (a) a historical database, (b) a dynamic database, (c) a predictive database, and (d) a combined database to determine a cost for each of the one or more time frames; and
providing, via the one or more processors, the one or more time frames and the respective costs for a user to select at least one of the one or more time frames and the respective cost as part of purchasing the item.

2. The method of claim 1 further comprising receiving a promised delivery date, wherein the determining of the one or more times frames is dependent on the promised delivery date.

3. The method of claim 1 further comprising determining, based on the customer location data, whether a synchronized visit with a stop creator shipment is possible to increase or decrease delivery density.

4. The method of claim 1 further comprising determining, based on the carrier data, whether a synchronized visit with a stop creator shipment is possible to increase or decrease delivery density.

5. The method of claim 1 further comprising, responsive to querying only the historical database, determining if costs are available for the customer location based on the address for the customer location or a nearby address for the customer location, the query result indicating one or more of (a) whether costs are available, (b) the type of costs including an address match with an anticipated stop creator shipment, (c) the type of costs including a nearby address match with an anticipated stop creator shipment, and (d) actual costs.

6. The method of claim 1 further comprising:
responsive to querying only the dynamic database, determining whether a synchronized visit with one or more stop creator items is possible and if costs are available; and
determining delivery criteria to be met to achieve the synchronized visit with the one or more stop creator items and to receive the costs, the delivery criteria based at least in part on an ability to synchronize the visit with forecasted deliveries to the particular address or the surrounding address.

7. The method of claim 1, further comprising:
providing a unique identifier with the cost for use in identifying the shipment, wherein when the shipment is tendered to the carrier;
capturing the unique identifier; and
verifying whether the shipment criteria has been met to receive the determined cost.

8. An apparatus comprising at least one processor and at least one memory including program code, the at least one memory and the program code configured to, with the processor, cause the apparatus to at least:
receive customer location data indicative of a customer location, the customer location data selected from the group consisting of entered data, customer profile data, and address data associated with the customer; and
determine one or more time frames from a plurality of carrier time frames in which delivery of the item is available based on the customer location;
query at least one selected from the group consisting of (a) a historical database, (b) a dynamic database, (c) a predictive database, and (d) a combined database to determine a cost for each of the one or more time frames; and
provide the one or more time frames and the respective costs for a user to select at least one of the one or more time frames and the respective cost as part of purchasing the item.

9. The apparatus of claim 8, wherein the memory and program code are further configured to, with the processor, cause the apparatus to receive a promised delivery date, wherein the determining of the one or more times frames is dependent on the promised delivery date.

10. The apparatus of claim 8, wherein the memory and program code are further configured to, with the processor, cause the apparatus to determine, based on the customer location data, whether a synchronized visit with a stop creator shipment is possible to increase or decrease delivery density.

11. The apparatus of claim 8, wherein the memory and program code are further configured to, with the processor, cause the apparatus to determine, based on the carrier data, whether a synchronized visit with a stop creator shipment is possible to increase or decrease delivery density.

12. The apparatus of claim 8, wherein the memory and program code are further configured to, with the processor, cause the apparatus to, responsive to querying only the historical database, determine if costs are available for the customer location based on the address for the customer location or a nearby address for the customer location, the query result indicating one or more of (a) whether costs are available, (b) the type of costs including an address match with an anticipated stop creator shipment, (c) the type of costs including a nearby address match with an anticipated stop creator shipment, and (d) actual costs.

13. The apparatus of claim 8, wherein the memory and program code are further configured to, with the processor, cause the apparatus to:
responsive to querying only the dynamic database, determine whether a synchronized visit with one or more stop creator items is possible and if costs are available; and
determine delivery criteria to be met to achieve the synchronized visit with the one or more stop creator items and to receive the costs, the delivery criteria based at least in part on an ability to synchronize the visit with forecasted deliveries to the particular address or the surrounding address.

14. The apparatus of claim 8, wherein the memory and program code are further configured to, with the processor, cause the apparatus to:
provide a unique identifier with the cost for use in identifying the shipment, wherein when the shipment is tendered to the carrier;
capture the unique identifier; and
verify whether the shipment criteria has been met to receive the determined cost.

15. A computer program product comprising at least one non-transitory computer-readable storage medium having computer-readable program code portions stored therein, the computer-readable program code portions comprising:
an executable portion configured to receive customer location data indicative of a customer location, the customer location data selected from the group consisting of entered data, customer profile data, and address data associated with the customer; and
an executable portion configured to determine one or more time frames from a plurality of carrier time frames in which delivery of the item is available based on the customer location;
an executable portion configured to query at least one selected from the group consisting of (a) a historical database, (b) a dynamic database, (c) a predictive database, and (d) a combined database to determine a cost for each of the one or more time frames; and
an executable portion configured to provide the one or more time frames and the respective costs for a user to select at least one of the one or more time frames and the respective cost as part of purchasing the item.

16. The computer program product of claim 15 further comprising an executable portion configured to receive a promised delivery date, wherein the determining of the one or more times frames is dependent on the promised delivery date.

17. The computer program product of claim 15 further comprising an executable portion configured to determine, based on the customer location data, whether a synchronized visit with a stop creator shipment is possible to increase or decrease delivery density.

18. The computer program product of claim 15 further comprising an executable portion configured to determine, based on the carrier data, whether a synchronized visit with a stop creator shipment is possible to increase or decrease delivery density.

19. The computer program product of claim 15 further comprising an executable portion configured to, responsive to querying only the historical database, determine if costs are available for the customer location based on the address for the customer location or a nearby address for the customer location, the query result indicating one or more of (a) whether costs are available, (b) the type of costs including an address match with an anticipated stop creator shipment, (c) the type of costs including a nearby address match with an anticipated stop creator shipment, and (d) actual costs.

20. The computer program product of claim 15 further comprising:
an executable portion configured to, responsive to querying only the dynamic database, determine whether a synchronized visit with one or more stop creator items is possible and if costs are available; and
an executable portion configured to determine delivery criteria to be met to achieve the synchronized visit with the one or more stop creator items and to receive the costs, the delivery criteria based at least in part on an ability to synchronize the visit with forecasted deliveries to the particular address or the surrounding address.

21. The computer program product of claim 15 further comprising an executable portion configured to:
an executable portion configured to provide a unique identifier with the cost for use in identifying the shipment, wherein when the shipment is tendered to the carrier;
an executable portion configured to capture the unique identifier; and
an executable portion configured to verify whether the shipment criteria has been met to receive the determined cost.
